(19) United States
(12) Patent Application Publication
(10) Pub. No.: US 2023/0263592 A1
(43) Pub. Date: Aug. 24, 2023

(54) MOUTHGUARD ASSEMBLY

(71) Applicant: Siegfried Settele, Dublin, OH (US)

(72) Inventor: Siegfried Settele, Dublin, OH (US)

(21) Appl. No.: 18/129,671

(22) Filed: Mar. 31, 2023

Related U.S. Application Data
(63) Continuation-in-part of application No. 18/100,358, filed on Jan. 23, 2023.
Application No. 18/100,358 is a continuation-in-part of application No. 17/479,723, filed on Sep. 20, 2021.
(60) Provisional application No. 63/237,573, filed on Aug. 27, 2021.
(60) Provisional application No. 63/080,216, filed on Sep. 18, 2020.

(51) Int. Cl. A61C 5/90; A63B 71/08

(52) U.S. Cl. CPC A61C 5/90; A63B 71/085

(57) ABSTRACT

A mouthguard assembly that includes a U-shaped body, a protective member, and a protective layer. The body includes a posterior wall, an anterior wall, and a middle bite portion disposed between the posterior wall and the anterior wall. The posterior wall and the anterior wall extend from the middle bite portion to define a groove. The protective member is at least partially embedded within the body, if not completely embedded within the body. The protective layer covers the teeth-side surface of the protective member. Also disclosed are methods for fabricating the mouthguard assembly.

### CROSS REFERENCE TO RELATED APPLICATIONS

This application is a continuation-in-part of U.S. Pat. Application No. 18/100,358, filed Jan. 23, 2023, which, in turn, is a continuation-in-part of U.S. Pat. Application No. 17/479,723, filed Sep. 20, 2021, which, in turn, claims priority to U.S. Provisional Application No. 63/080,216, filed Sep. 18, 2020, and to U.S. Provisional Application No. 63/237,573, filed Aug. 27, 2021. U.S. Pat. Application No. 18/100,358, U.S. Pat. Application No. 17/479,723, U.S. Provisional Application No. 63/080,216, and U.S. Provisional Application No. 63/237,573 are all hereby incorporated by reference as if fully recited herein.

### TECHNICAL FIELD

Exemplary embodiments relate generally to mouthguard assemblies and methods for manufacturing mouthguard assemblies, including mouthguard assemblies adapted for use with dental braces.

### BACKGROUND

Players of contact sports (e.g., football, basketball, hockey, etc.), often experience impacts to their heads and bodies during the course of a match. These impacts may occur, among other reasons, due to the player falling, hitting objects (e.g., soccer balls), and/or colliding with other players. To protect themselves, players often wear protective equipment to deflect and/or cushion these impacts.

Mouthguards are a common piece of protective equipment designed to protect the user’s mouth (e.g., teeth and soft tissues). In the event the user experiences a blow to the head, a mouthguard can help redistribute the force of the blow, thereby minimizing the risk of broken or lost teeth, as well as injuries to the user’s lips, tongue, gums, and cheeks.

Conventional mouthguards typically feature a unibody design, fabricated as a single piece. This means that the mouthguard will exhibit a flexural rigidity that is reflective of the material used to fabricate it. A soft (i.e., flexible) mouthguard may be relatively comfortable to wear, but offers less protection in the event of a direct impact to the user’s head. Soft mouthguards may also degrade or fail quicker than a hard mouthguard. Hard (i.e., rigid) mouthguards may serve as a better brace against an impact but may be less comfortable for the user to wear or bite against.

Moreover, those skilled in the art will appreciate that conventional mouthguards may not be suitable for use with dental braces. Dental braces are orthodontic devices used to align and straighten teeth. Typically, dental braces consist of four main components - an arch wire, a plurality of brackets, a bonding material (i.e., adhesive), and a plurality of ties (e.g., ligature elastics, O-rings, etc.). The brackets are individually attached to each of a user’s teeth using the bonding material. The arch wire is then fitted into or through the brackets and held in place by the ties. The teeth move when the arch wire puts pressure on the brackets and teeth. Sometimes, springs or rubber bands are also used to put more force in a specific direction.

The fact that dental braces are adhered to tooth surfaces means that the components of dental braces (when applied) will jut or protrude outwards into the user’s oral cavity (i.e., the space defined between the arch of the hard and soft palates above, the teeth and cheeks laterally, and the tongue on the floor of the mouth) and/or the user’s oral vestibule (i.e., space defined between the user’s lips and cheeks and user’s the teeth and gums). This can prevent conventional mouthguards from fitting properly since conventional mouthguards are generally made with smooth bite surfaces (i.e., areas/portions) that match the generally smooth surfaces of non-dental-brace-having teeth/gums. The braces, due to jutting or protruding out, prevents the conventional mouthguard from fitting as close as it normally would to a user’s dental arch. The result is an uncomfortable and possibly unsafe wearing experience.

What is needed is a mouthguard that is comfortable for the user to wear or bite against, but can also resist/minimize/disperse the force of an impact before it is transferred to the user’s teeth. Accordingly, those skilled in the art continue with research and development efforts in the field of mouthguard design.

### SUMMARY OF THE INVENTION

Disclosed are mouthguard assemblies and methods for manufacturing the same.

In one embodiment, the mouthguard assembly includes a U-shaped body that includes a posterior wall, an anterior wall, and a middle bite portion disposed between the posterior wall and the anterior wall. The posterior wall and the anterior wall extend from the middle bite portion to define a groove. The protective member is at least partially embedded within the body and the protective member includes a rigid material composition. The trough member is received in the groove of the body and defines a trough for receiving at least part of a dental arch.

In one embodiment, the mouthguard assembly includes a U-shaped body that includes a posterior wall, an anterior wall, and a middle bite portion disposed between the posterior wall and the anterior wall. The posterior wall and the anterior wall extend from the middle bite portion to define a groove. The protective member is at least partially embedded within the body and the protective member includes a rigid material composition. The trough member is a brace member and is received in the groove of the body. The brace member defines a trough for receiving at least part of a dental arch.

In one embodiment, the mouthguard assembly includes a U-shaped body that includes a posterior wall, an anterior wall, and a middle bite portion disposed between the posterior wall and the anterior wall. The posterior wall and the anterior wall extend from the middle bite portion to define a groove. The protective member is at least partially embedded within the body and the protective member includes a rigid material composition. The trough member is a cushioning member and is received in the groove of the body. The cushioning member defines a trough for receiving at least part of a dental arch.

In one embodiment, the mouthguard assembly includes a U-shaped body that includes a posterior wall, an anterior wall, and a middle bite portion disposed between the posterior wall and the anterior wall. The posterior wall and the anterior wall extend from the middle bite portion to define a groove. The mouthguard assembly further includes a brace member receivable in the groove of the body. The brace member includes a posterior wall, an anterior wall, and a middle bite portion disposed between the posterior wall and the anterior wall. The posterior wall and the anterior wall extend from the middle bite portion to define a trough. The mouthguard assembly further includes a slot defined in at least one of the anterior wall and posterior wall of the brace member facing the trough, wherein the slot provides space for receiving a component of dental braces.

In one embodiment, the mouthguard assembly includes a U-shaped body that includes a posterior wall, an anterior wall, and a middle bite portion disposed between the posterior wall and the anterior wall. The posterior wall and the anterior wall extend from the middle bite portion to define a groove. The mouthguard assembly further includes a protective member embedded within the body and a brace member receivable in the groove of the body. The brace member includes a posterior wall, an anterior wall, and a middle bite portion disposed between the posterior wall and the anterior wall. The posterior wall and the anterior wall extend from the middle bite portion to define a trough. The mouthguard assembly further includes a slot defined in at least one of the anterior wall and posterior wall of the brace member facing the trough, wherein the slot provides space for receiving a component of dental braces. The brace member defines a bottom side that includes a pair of cantilever arms and the body and the protective member each include aligned, corresponding holes that are suitable for indexing the cantilever arms.

In one embodiment, the mouthguard assembly includes a U-shaped body that has a posterior wall, an anterior wall, and a middle bite portion disposed between the posterior wall and the anterior wall. The posterior wall and the anterior wall extend from the middle bite portion to define a groove. The mouthguard assembly further includes a protective member at least partially embedded within the body. The protective member has a rigid material composition. The mouthguard assembly further includes a protective layer covering the teeth-side surface of the protective member.

Further features and advantages of the mouthguard assembly and methods disclosed herein, as well as the structure and operation of various aspects of the present disclosure, are described in detail below with reference to the accompanying figures.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is a perspective view of a first exemplary embodiment of the mouthguard assembly of the present disclosure;

FIG. 2 is a top plan view of the mouthguard assembly of FIG. 1;

FIG. 3 is a top plan view of an embodiment of the mouthguard assembly having separate protective member;

FIG. 4 is a perspective view of an embodiment of the mouthguard assembly that has been customized for a wearer;

FIG. 5 is side cross-sectional view of the mouthguard assembly of FIG. 1;

FIG. 6 is a side cross-sectional view of an embodiment of the mouthguard assembly having two protective members and two cushioning members;

FIG. 7 is side cross-sectional view of an embodiment of the mouthguard assembly having a protective member that is completely embedded within the body;

FIG. 8 is a front elevation view of a second exemplary embodiment of the mouthguard assembly of the present disclosure;

FIG. 9 is an exploded view of the mouthguard of FIG. 8 that shows the body and the brace member;

FIG. 10 is a top plan view of the mouthguard assembly of FIG. 8;

FIG. 11 is a bottom plan view of the mouthguard assembly of FIG. 8;

FIG. 12 is a perspective exploded view of the mouthguard assembly of FIG. 8 that shows the body, the brace member, and a protective member;

FIG. 13 is a cross-sectional view of a protective layer and a body that has been overmolded over the protective layer;

FIG. 14 is a diagram of the mouthguard assembly of FIG. 8 received over a dental arch showing the interlay between the brace member and the body;

FIG. 15 is a bottom plan view of the mouthguard assembly of FIG. 8 received over a dental arch;

FIG. 16 is a perspective view of the mouthguard assembly of FIG. 8 received over a dental arch;

FIG. 17 is a side elevation view of the mouthguard assembly of FIG. 8 received over a dental arch;

FIG. 18 is a cross-sectional view of a portion of the mouthguard assembly of FIG. 8 received over a dental arch;

FIG. 19 is a perspective view of a jeweled mouthguard assembly;

FIG. 20 is a side cross-sectional view of an embodiment of the mouthguard assembly that includes an EVA copolymer body, a polycarbonate protective member, and an EVA copolymer cushioning member;

FIG. 21 is a side cross-sectional view of an embodiment of the mouthguard assembly that includes an EVA copolymer body, an ABS protective member, and an EVA copolymer cushioning member;

FIG. 22 is a side cross-sectional view of an embodiment of the mouthguard assembly that includes an EVA copolymer body, a HDPE protective member, and an EVA copolymer cushioning member;

FIG. 23 is a side cross-sectional view of an embodiment of the mouthguard assembly that includes an EVA copolymer body, a polycarbonate protective member, and a denture liner cushioning member;

FIG. 24 is a side cross-sectional view of an embodiment of the mouthguard assembly that includes an EVA copolymer body, an ABS protective member, and a denture liner cushioning member;

FIG. 25 is a side cross-sectional view of an embodiment of the mouthguard assembly that includes an EVA copolymer body, a HDPE protective member, and a denture liner cushioning member;

FIG. 26 is a side cross-sectional view of an embodiment of the mouthguard assembly that includes an EVA copolymer body, a vitallium protective member, and an EVA copolymer cushioning member;

FIG. 27 is a side cross-sectional view of an embodiment of the mouthguard assembly that includes an EVA copolymer body, a titanium protective member, and an EVA copolymer cushioning member;

FIG. 28 is a side cross-sectional view of an embodiment of the mouthguard assembly that includes an EVA copolymer body, a stainless-steel protective member, and an EVA copolymer cushioning member;

FIG. 29 is a side cross-sectional view of an embodiment of the mouthguard assembly that includes an EVA copolymer body, a vitallium protective member, and a denture liner cushioning member;

FIG. 30 is a side cross-sectional view of an embodiment of the mouthguard assembly that includes an EVA copolymer body, a titanium protective member, and a denture liner cushioning member;

FIG. 31 is a side cross-sectional view of an embodiment of the mouthguard assembly that includes an EVA copolymer body, a stainless-steel protective member, and a denture liner cushioning member;

FIG. 32 is a side cross-sectional view of an embodiment of the mouthguard assembly that includes an EVA copolymer body, a polycarbonate protective member, and a silicone elastomer cushioning member;

FIG. 33 is a side cross-sectional view of an embodiment of the mouthguard assembly that includes an EVA copolymer body, an ABS protective member, and a silicone elastomer cushioning member;

FIG. 34 is a side cross-sectional view of an embodiment of the mouthguard assembly that includes an EVA copolymer body, a HDPE protective member, and a silicone elastomer cushioning member;

FIG. 35 is a side cross-sectional view of an embodiment of the mouthguard assembly that includes an EVA copolymer body, a vitallium protective member, and a silicone elastomer cushioning member;

FIG. 36 is a side cross-sectional view of an embodiment of the mouthguard assembly that includes an EVA copolymer body, a titanium protective member, and a silicone elastomer cushioning member;

FIG. 37 is a side cross-sectional view of an embodiment of the mouthguard assembly that includes an EVA copolymer body, a stainless-steel protective member, and a silicone elastomer cushioning member;

FIG. 38 is a side cross-sectional view of an embodiment of the mouthguard assembly that includes a silicone elastomer body, a polycarbonate protective member, and an EVA copolymer cushioning member;

FIG. 39 is a side cross-sectional view of an embodiment of the mouthguard assembly that includes a silicone elastomer body, an ABS protective member, and a denture liner cushioning member;

FIG. 40 is a side cross-sectional view of an embodiment of the mouthguard assembly that includes a silicone elastomer body, a HDPE protective member, and a silicone elastomer cushioning member;

FIG. 41 is a side cross-sectional view of an embodiment of the mouthguard assembly that includes a silicone elastomer body, a vitallium protective member, and an EVA copolymer cushioning member;

FIG. 42 is a side cross-sectional view of an embodiment of the mouthguard assembly that includes a silicone elastomer body, a titanium protective member, and a denture liner cushioning member;

FIG. 43 is a side cross-sectional view of an embodiment of the mouthguard assembly that includes a silicone elastomer body, a stainless-steel protective member, and a silicone elastomer cushioning member;

FIG. 44 is a flow diagram of a method of manufacturing a mouthguard assembly;

FIG. 45 is a rear view of a dental model;

FIG. 46 is a rear view of the dental model of FIG. 33 with a dental tray placed on top;

FIG. 47 is a rear view of a second dental model created from the dental model of FIG. 33 with the dental tray of FIG. 34 on top;

FIG. 48 is a rear view of the second dental model of FIG. 35 with a second dental tray placed on top;

FIG. 49 is a rear view of the dental model of FIG. 36 with a custom metal sleeve placed on top;

FIG. 50 is a rear view of a finished mouthguard assembly;

FIG. 51 is a side elevation view of a third exemplary embodiment of the mouthguard assembly;

FIG. 52 is a top plan view of the mouthguard assembly of FIG. 51 received over a dental arch;

FIG. 53 is a top perspective view of the brace member of the mouthguard assembly of FIG. 51 received over a dental arch;

FIG. 54 is a first side cross-sectional view of the brace member of FIG. 51;

FIG. 55 is a second side cross-sectional view of the brace member of FIG. 51; and

FIG. 56 is a top plan view of the brace member of FIG. 51.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

Embodiments of the invention are described herein with reference to illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

The present disclosure relates to mouthguard assemblies that may be worn by a person (herein referred to as a “user”) to protect his/her mouth in the event of physical contact, such as during the play of contact sports like football and hockey. The mouthguard assemblies disclosed herein each comprise multiple components that, when assembled, impart different qualities and benefits to overall mouthguard assembly.

### Embodiments of the Mouthguard Assembly

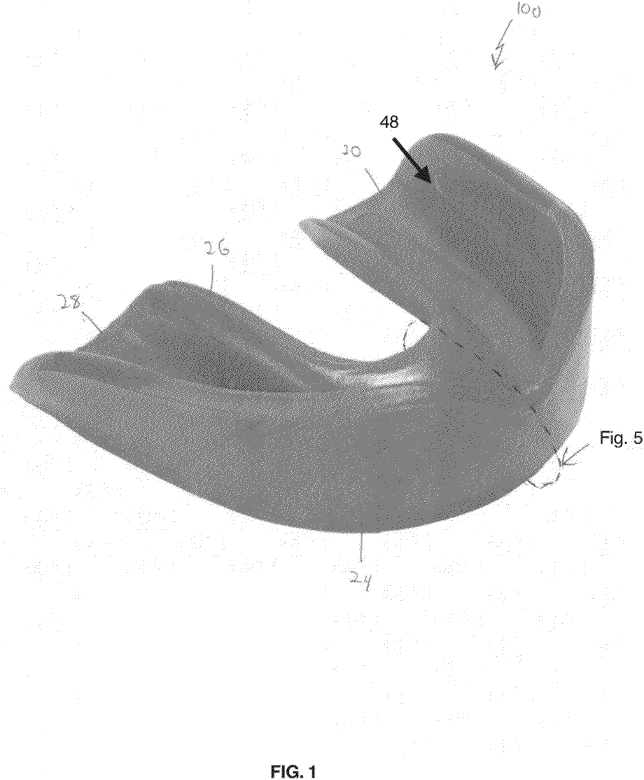

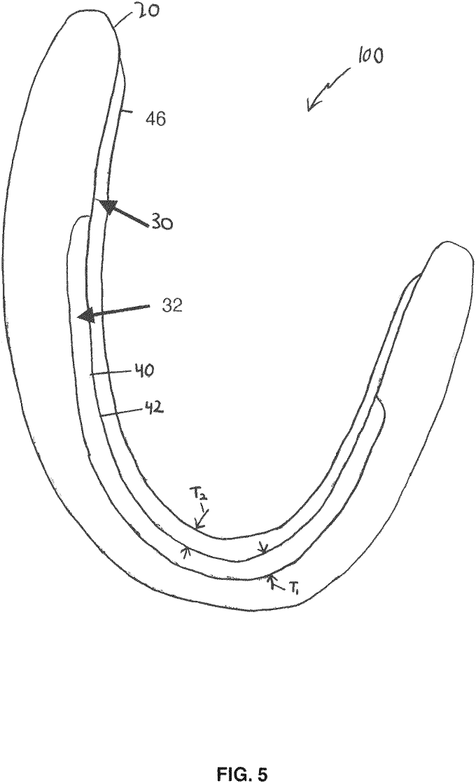

Referring to FIG. 1, the present disclosure provides a first exemplary embodiment of a mouthguard assembly 100. The mouthguard assembly 100 includes a body 20, a protective member 40, and a cushioning member 46 (FIG. 5). The body 20 provides a bite surface for a user to bite on, cushions the force of a direct impact to the user’s teeth, and is configured to receive the protective member 40 and the cushioning member 46. The protective member 40 serves to redistribute the force of an impact and the cushioning member 46 dampens the impact against the user’s teeth and gums. Each of these components are described in greater detail below.

The body 20 may be generally U-shaped and includes an anterior wall 24, a posterior wall 26, and a middle bite portion 28. Groove 30 is defined therebetween. The protective member 40 may be embedded within the body 20 and the cushioning member 46 may be applied to the groove.

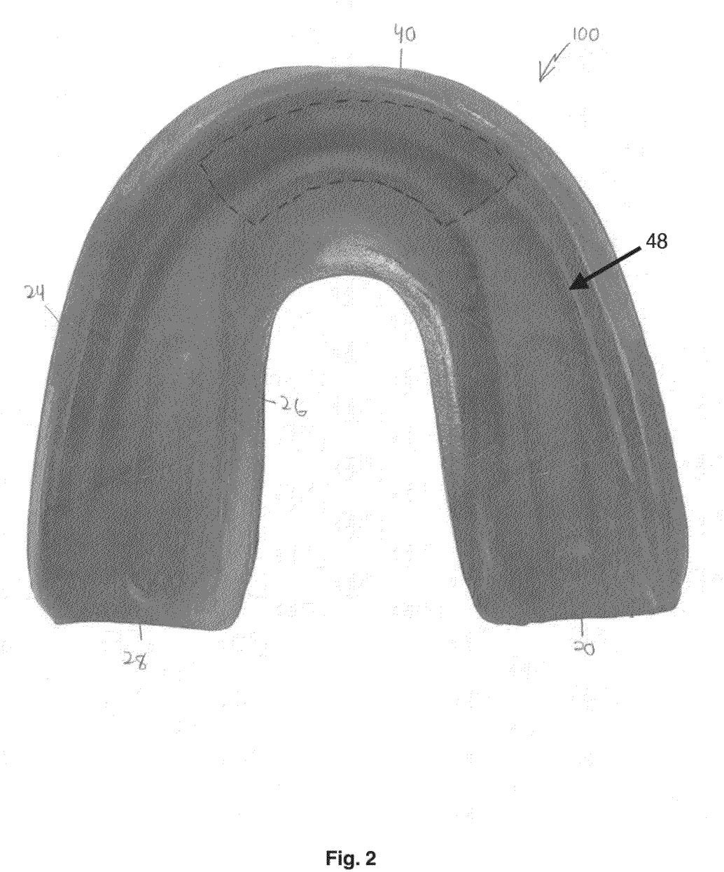

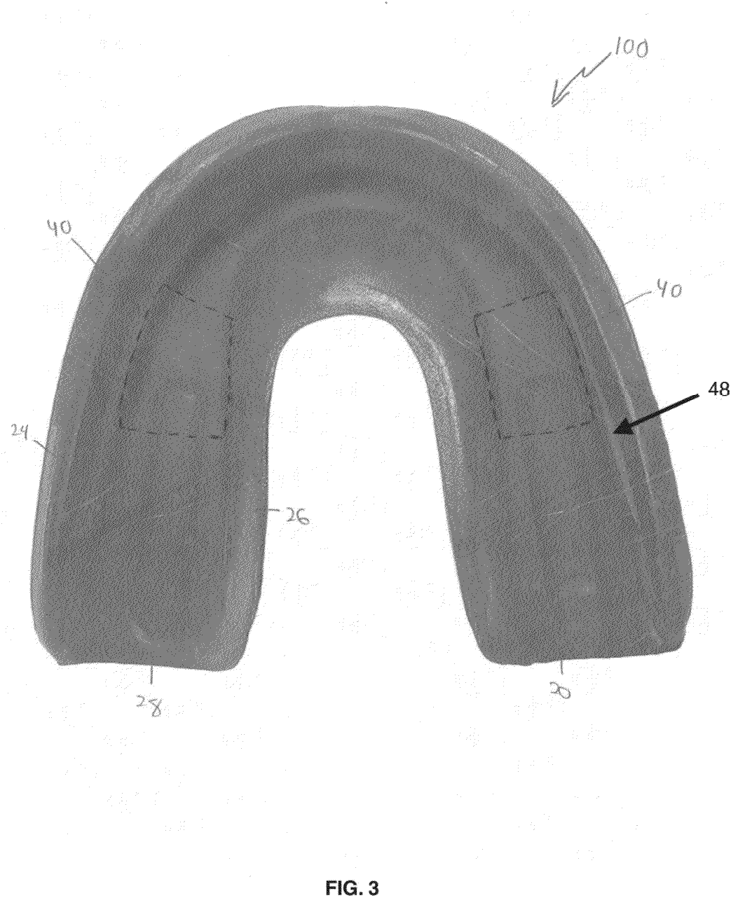

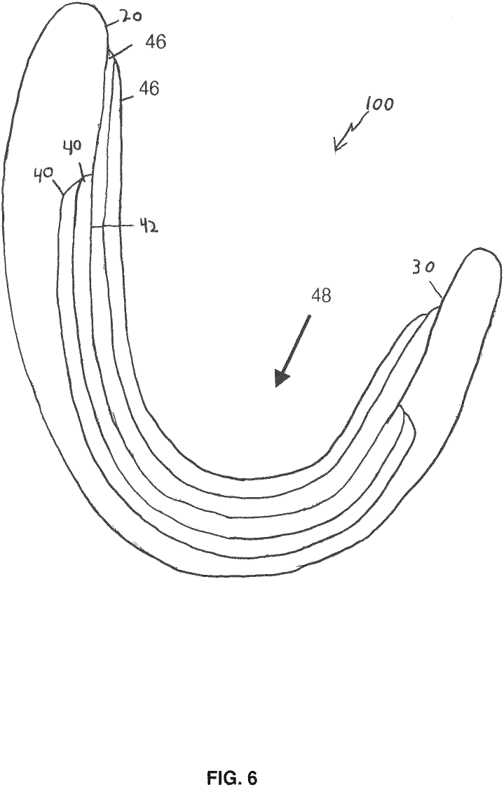

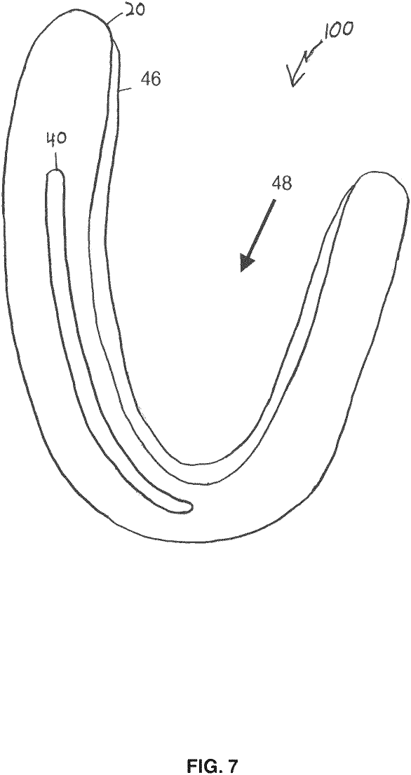

As shown in FIGS. 2-3, one or more protective members 40 may be embedded within the anterior wall 24, the posterior wall 26, and/or the bite portion 28. The manner in which one or more protective members 40 is embedded within the body 20 may, but need not, be a limiting feature. In FIG. 5, for example, the body 20 defines an indent 32 in the groove 30 and the protective member 40 is embedded within that indent 32. Here, one side 42 of the protective member 40 is left exposed. In alternative embodiments, it is also contemplated that the protective member 40 may be completely embedded within the body 20 instead (FIG. 7).

Design considerations for the protective member(s) 40 may include, for example, which teeth are most vulnerable based on the types of impacts the user is likely to experience. For example, the mouthguard assembly 100 may include a single protective member 40 extending from the anterior wall 24 to the posterior wall 26 that encompasses the user’s eight forwardmost teeth (i.e., the user’s central incisors, lateral incisors, canines, and first premolars) (e.g., FIG. 2). This design may be suitable for protecting against forward-on impacts to the user’s face. Other designs may include, for example, separate protective members 40 disposed at different locations in the mouthguard body 20 (FIG. 3), and/or multiple protective members 40 disposed in a layered arrangement (FIG. 6). Further, protective members 40 may also vary in terms of size and shape (e.g., by encompassing either more or less teeth), as well as thickness T₁. Those skilled in the art will appreciate that variations in these design features may be incorporated without departing from the scope of the present disclosure.

As shown in FIGS. 5-7, cushioning member 46 may be applied to the groove 30 (with or without an exposed side of the protective member 40) to cushion the force of an impact transferred from the mouthguard assembly 100 to the user. In doing so, the cushioning member 46 may effectively prevent the rigid protective member 40 from colliding into and injuring the user’s mouth. The cushioning member 46 may be applied to the entirety of the groove 30, or just part of it. Physical dimensions such as the thickness T₂ of the cushioning member 46 are not meant to be limiting. Further, it is also contemplated that additional cushioning member 46 may be provided in a layered arrangement for added cushioning (FIG. 6).

The cushioning member 46, and perhaps also the body 20 to some degree (specifically the groove 30), defines a trough 48 in the mouthguard assembly 100 that is configured to receive a user’s teeth, thereby enabling the user to wear the mouthguard assembly 100. For this reason, the cushioning member 46 is considered a type of “trough member.”

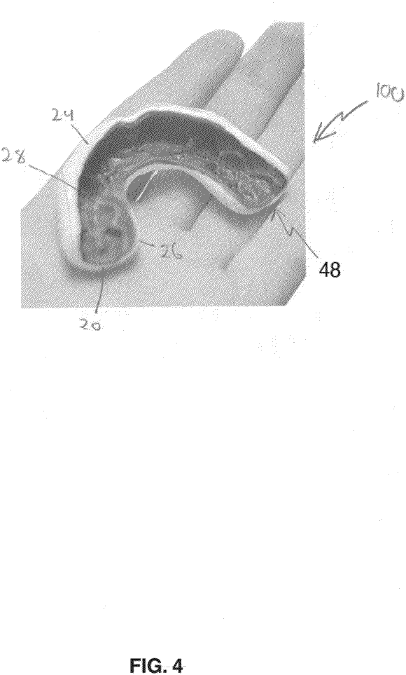

The trough 48 may be shaped as appropriate to provide varying degrees of fit. The term “fit” can range from a stock (i.e., loose) fit to a custom (i.e., tight) fit. For example, in various embodiments, the trough 48 may be fabricated in a stock fit that only generally corresponds to the curvature of a user’s teeth (FIG. 2). In other embodiments, the trough 48 may be fabricated in a custom fit that features individualistic depressions and curves that more closely matches the shape of a single user’s teeth (FIG. 4).

The overall size of the mouthguard assembly 100 may be varied as needed to accommodate different users (e.g., youth and adult sizes). In one embodiment, the mouthguard assembly 100 may have a length of about 2 inches to about 3 inches, preferably about 2.5 inches; a width of about 2 inches to about 3 inches, preferably about 2.5 inches; and a height of about 0.5 inches to about 1 inch, preferably about 0.75 inches. A mouthguard assembly 100 with of this size may be suitable for an adult user.

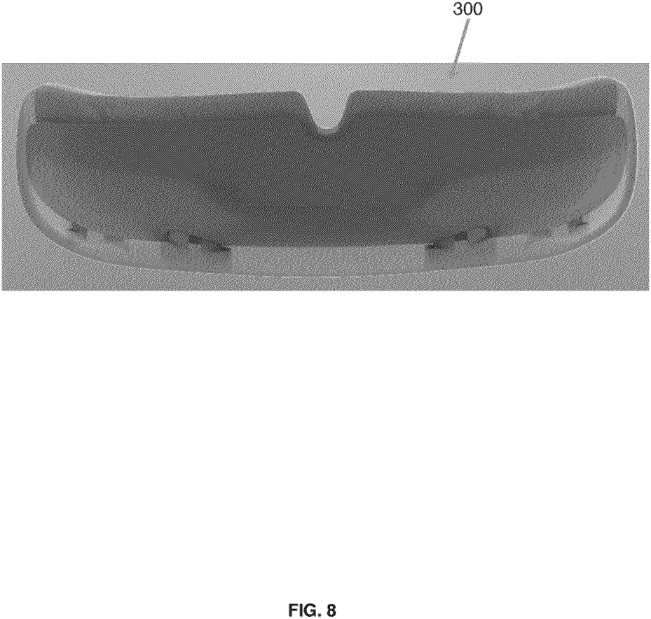

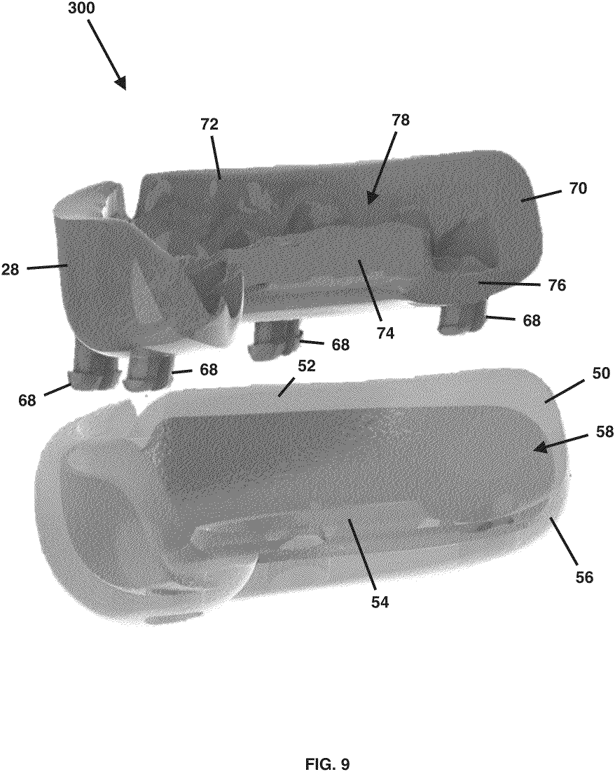

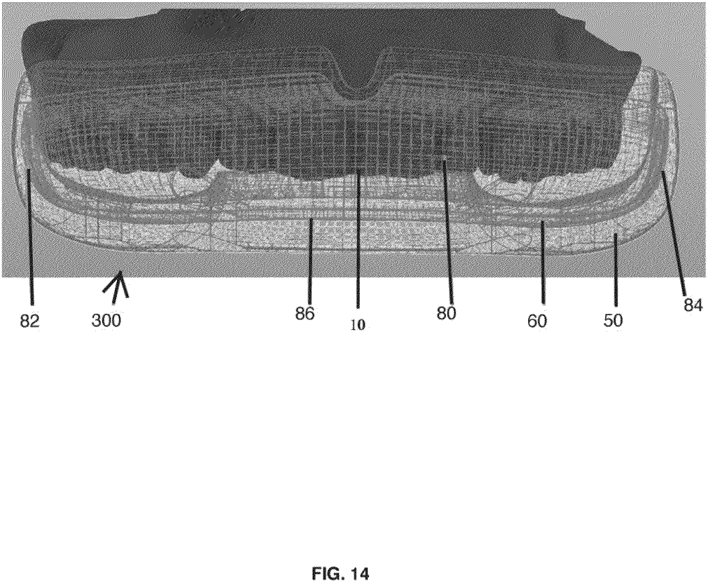

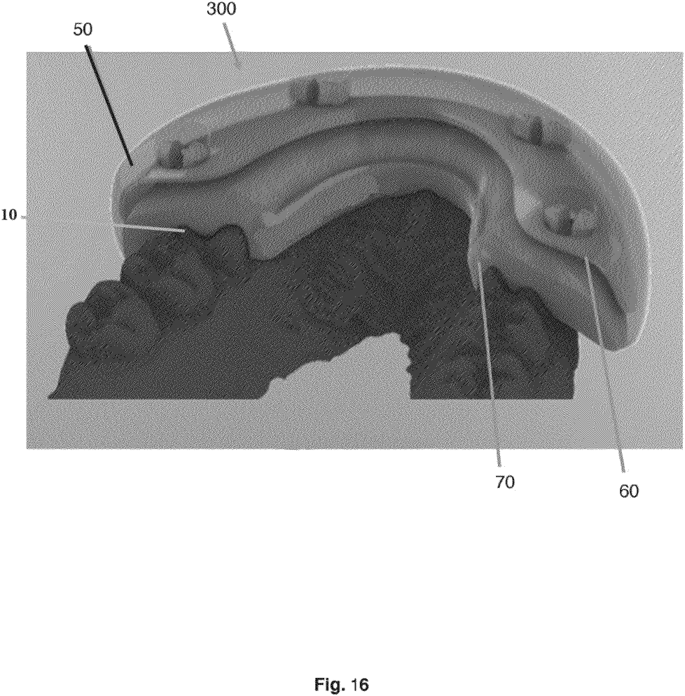

Referring to FIG. 8, the present disclosure provides a second exemplary embodiment of the mouthguard assembly 300. The mouthguard assembly 300 includes body 50, protective member 60, and brace member 70 (FIG. 9). The brace member 70 is configured to closely encompass (i.e., be received over) a user’s dental arch 10 (i.e., a row of teeth, shown in FIGS. 14-18). The body 50 is attachable to the brace member 70 and provides an opposing bite surface 52 (best shown in FIG. 4). In effect, the brace member 70 braces the user’s teeth 10 (i.e., prevents or limits involuntary movement) when the user experiences physical contact (e.g., the force of an impact); and the body 50 cushions (i.e., disperses, minimizes, or eliminates) the force of impact before it is transferred to the brace member 70.

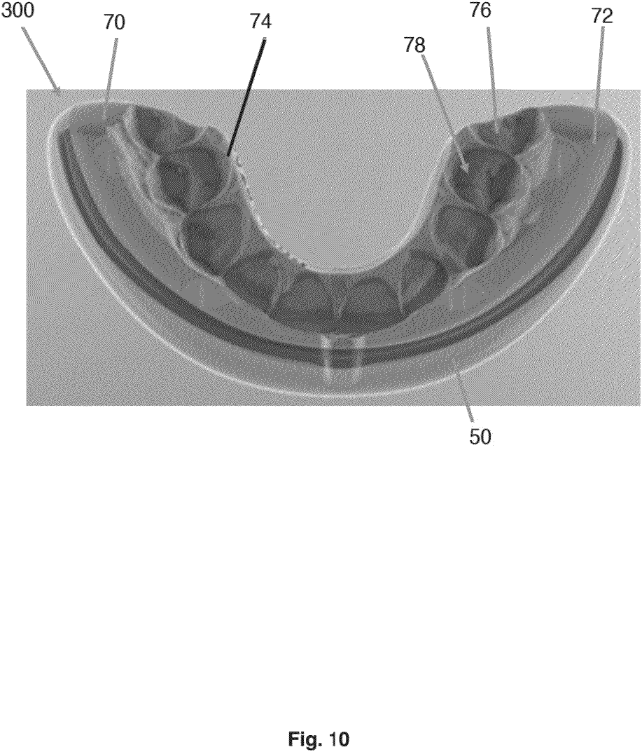

Referring to FIGS. 9 and 10, the brace member 50 is another type of trough member because it defines a trough 78 that a user may insert his/her teeth 10 into. Here, the brace member 70 is generally U-shaped and includes a posterior wall 72, an anterior wall 74, and a middle bite portion 76. Trough 78 is defined between therebetween.

The brace member 70 defines a number of external sides that are external to trough 78. These sides include labial side 80, buccal sides 82 and 84, incisal side 86, and lingual side 88 (see also FIG. 14).

The height of the posterior wall 72 and the anterior wall 74 may, but need not, be a limiting feature. These walls 72, 74 may be fabricated at various heights to accommodate different users or to encompass varying degrees of tooth surface. A relatively tall anterior wall 74 may reach up to the user’s gums, whereas a relatively short anterior wall 74 may only encompass part of the user’s labial and/or buccal tooth surfaces. Those skilled in the art will appreciate that the height of the posterior wall 72 may vary in the same way.

The fit of the trough 78 may, but need not, be a limiting feature. In various embodiments, the fit can range from a stock (i.e., loose) fit to a custom (i.e., tight) fit. For example, the trough 78 may be fabricated in a stock fit that only generally corresponds to the curvature of a user’s teeth 10. In other embodiments, the trough 78 may be fabricated in a custom fit that features individualistic depressions and curves that more closely matches the shape of a single user’s teeth 10. In the embodiment shown, which is a preferred embodiment, the trough 18 is essentially a negative impression of a user’s teeth 10.

Preferably, brace member 70 may be fabricated with a trough 78 having a fitment ranging from about 50 microns to about 200 microns. As used herein, the term “fitment” refers to the fit of brace member 70 over a particular user’s teeth. It is quantified based on the amount of space, gap, or clearance provided between the front and rear surfaces of a user’s teeth (or, if applicable, of the braces on the user’s teeth) and the front and rear surfaces of trough 78, as measured from the widest point between them. For example, if the widest gap between the front surface of a user’s tooth and the front surface of trough 78 is 75 microns and the widest gap between the rear surface of user’s tooth and the rear surface of trough 78 is 60 microns, the fitment would be 135 microns.

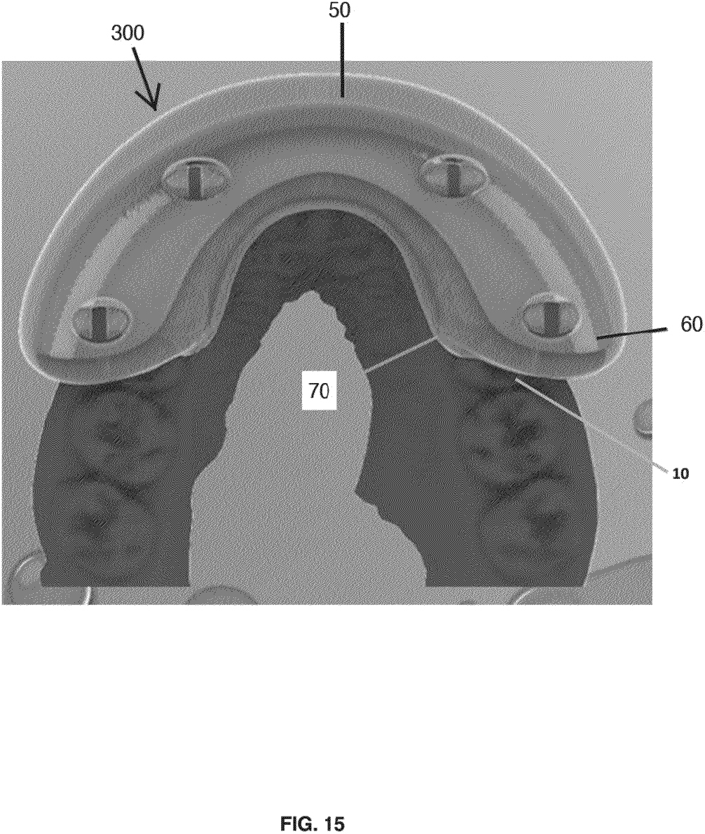

The number of teeth that the brace member 70 is configured to encompass may, but need not, be a limiting feature. The embodiment shown features a brace member 70 that is designed to encompass the front ten teeth of a user’s upper dental arch - both central incisors, both lateral incisors, both canines, both first premolars, and part of both second premolars (best shown in FIGS. 10 and 15). In different embodiments, however, the brace member 70 may only be configured to encompass a user’s incisors and canines. In another embodiment, the brace member 70 may be configured to encompass a user’s front eight teeth which includes a user’s incisors, canines, and first premolars. In yet other embodiments, the brace member 70 may be configured to further encompass all of the user’s second premolars and one or more of the user’s molars. Variations such as these will not depart from the scope of the present disclosure.

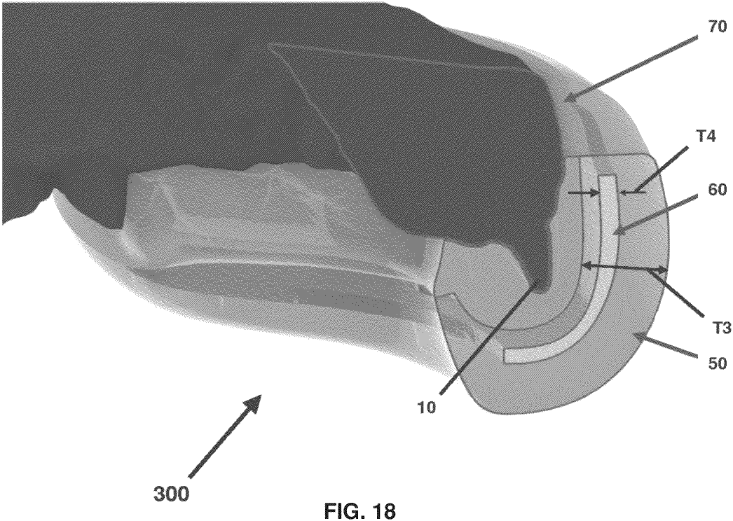

Referring to FIG. 10, the body 50 of the mouthguard assembly 300 may be generally U-shaped, and may be configured to encompass (i.e., be received over) the brace member 70. The body 50 may be curved in cross-section (best shown in FIG. 18) such that a groove 58 is defined. Here, the body includes an anterior wall 52, a middle bite portion 56, and a short posterior wall 54 (FIG. 9). The brace member 70 may be received by the body 50 by inserting the bottom of the brace member 70 into the groove 58. In effect, the body 50 may cushion the force of a direct impact to the user’s teeth 10; and may also prevent the user from biting against the brace member 70 (which is likely more rigid).

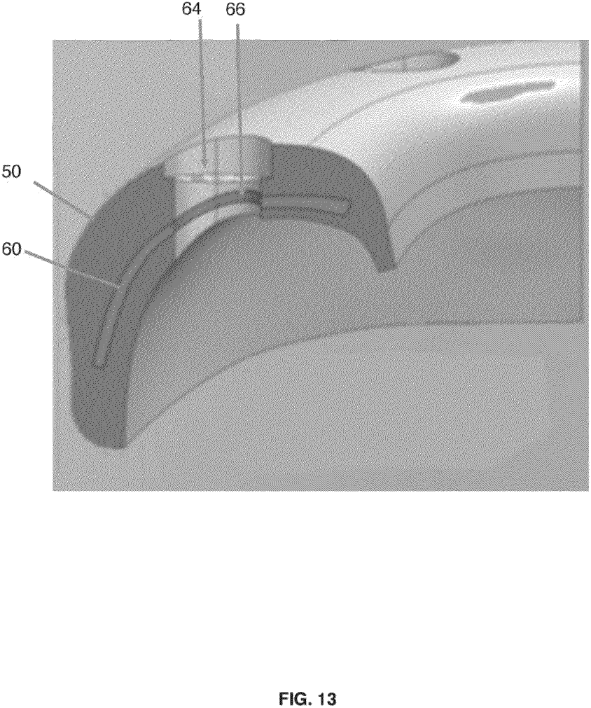

The degree to which the body 50 encompasses the brace member 70 may, but need not, be a limiting feature. In the embodiment shown, the body 50 encompasses all of the labial side 80 and the buccal sides 82, 84 of the brace member 70, extends around the incisal side 86, and tapers off at the brace member posterior wall 72 (best shown in FIGS. 13 and 18). This body 50 is, in effect, a layer of cushioning material around the front and bottom of the brace member 70. In other embodiments, however, it is contemplated that the body 50 may encompass less than all of the labial and/or buccal sides 80, 82, 84 of the brace member 70; and/or part of lingual side 88.

In the embodiment shown, it is contemplated since the body 50 does not encompass the brace member posterior wall 72, the extra space afforded to the user may enable greater tongue freedom, thereby making it easier for the user to talk, breathe, and swallow.

Each portion of the body 50 - i.e., the anterior wall 52, middle bite portion 56, and posterior wall 54 - can be considered as generally having multiple sections - i.e., a front section that generally covers the incisors and canines of a dental arch and opposing side sections that generally cover the molars and premolars of a dental arch. From embodiment to embodiment, these sections may be fabricated with varying thicknesses (e.g., T₃ in FIG. 18 which shows the cross-sectional thickness of the front section of body 50) to suit various needs and applications. For example, added thickness may be desired to enhance cushioning for combat sports such as boxing and mixed martial arts; and less thickness may be desired to reduce bulk and overcrowding within a user’s mouth, which may improve overall comfort and the ability to speak while wearing the mouthguard assembly.

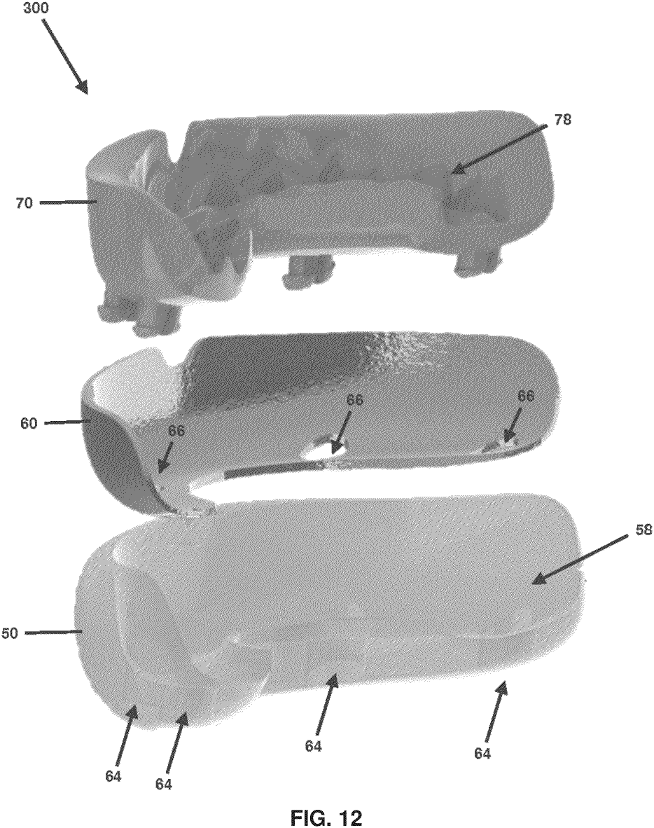

Referring to FIG. 12, in preferred embodiments, the mouthguard assembly 300 may further include a protective member 60 positioned in front of the brace member 70. A protective member 60 is a piece of rigid material that may help to minimize or disperse the force of an impact before the force is transferred to the brace member 70. A protective member 60 may also impart a degree of rigidity to the body 50.

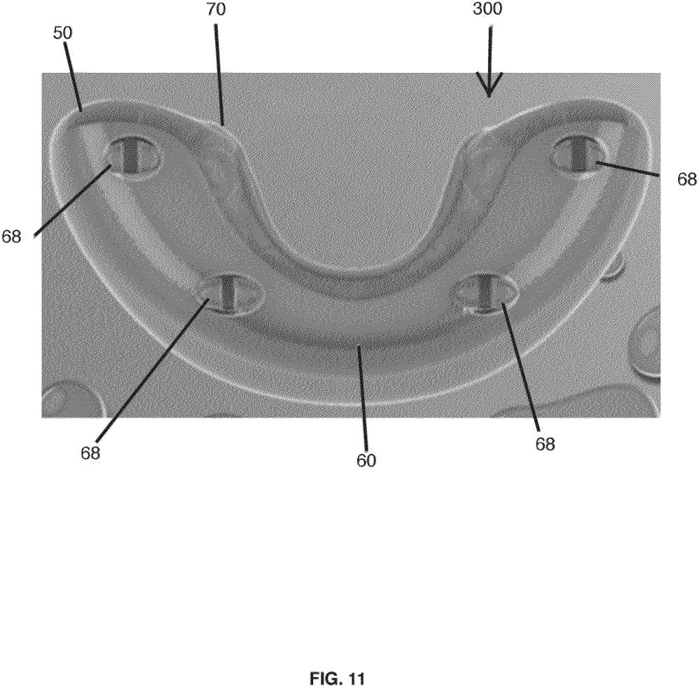

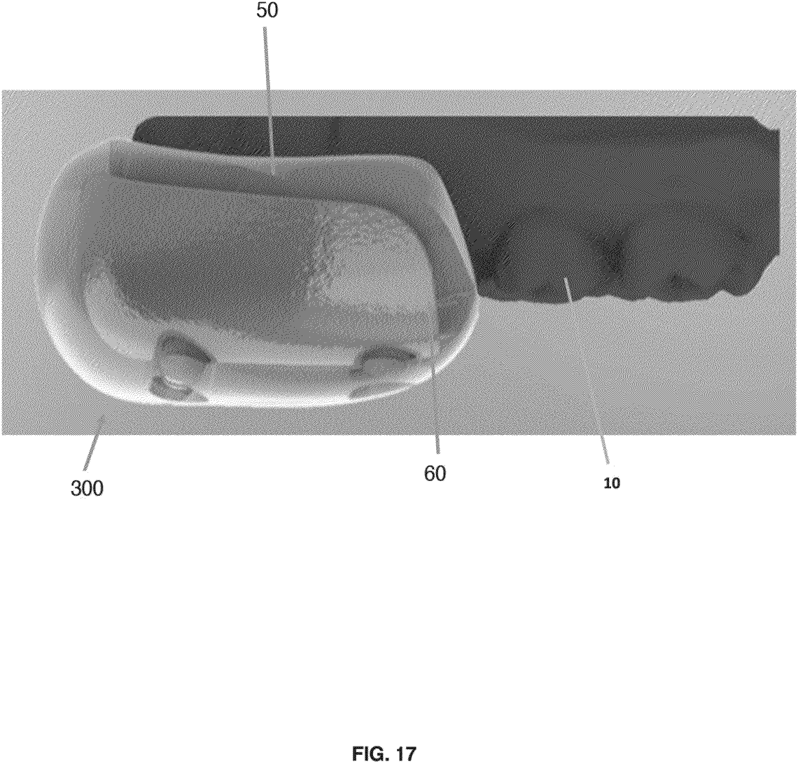

In the embodiment shown, the mouthguard assembly 300 includes a generally U-shaped protective member 60 (FIG. 11) that is configured to cover (i.e., be disposed in front of) a major part of the labial and buccal sides 80, 82, 84 of the brace member 70 (FIGS. 17 and 18). This protective member 60 is also curved, like the body 50, such that coverage extends below the middle bite portion 76 of the brace member 70 to the incisal side 86.

Other embodiments may differ by having shorter or smaller protective members 60. For example, it is contemplated that a protective member 60 that only covers the labial side 80 may be provided, or a protective 60 member that only covers the labial and buccal sides 80, 82, 84. Variations such as these will not result in a departure from the scope of the present disclosure.

Other embodiments may also differ by having multiple protective members 60, instead of just one. For example, it is contemplated that a mouthguard assembly 300 may be provided with a protective member 60 configured to cover the left buccal side 82 and another protective member 60 configured to cover the right buccal side 84. Variations such as these will not result in a departure from the scope of the present disclosure.

Referring back to FIGS. 14-18, it is shown that the protective member 60 may be embedded within the body 50 and may be spaced a distance D apart from an external surface on the brace member 70. The spacing between the protective member 60 and the brace member 70 may, but need not, be a limiting feature. The spacing between the brace member 70 and the protective member 60 may, but need not, be equidistant across the mouthguard assembly 300. In various embodiments, the protective member 60 may be closer to the brace member 70 in some areas or spaced further away in others.

In various embodiments, it is also contemplated that the protective member 60 may be directly received against an external surface of the brace member 70, instead of being embedded within the body 50. In such cases, it is contemplated that an appropriate indent may be provided within the groove 58 of the body 50 to accommodate the protective member 60.

Referring to FIG. 18, the thickness T₄ of the protective member 60 may, but need not, be a limiting feature. This thickness T₄ may be varied as desired to provide varying degrees of protection. This thickness T₄ may also be varied depending on the material composition of the protective member. Preferably, for protective members having a composite material composition (e.g., fiber glass and/or polymeric materials) the thickness T₄ may range from about 0.8 millimeters to about 2.0 millimeters, or more preferably from about 1.0 millimeters to about 1.5 millimeters. Preferably, for protective members having a metal material composition (namely, but not limited to, stainless steel) the thickness T₄ may range from about 0.2 millimeters to about 1.0 millimeters, or more preferably from about 0.4 millimeters to about 0.7 millimeters.

Those skilled in the art will appreciate that the body 50, the brace member 70, and the protective member 60 may be scaled up or down in size to accommodate different users. For example, the mouthguard 300 may be fabricated in small, medium, and large sizes to account for the differences in the dental arches 10 of youth and adult users, or between male and female users.

The means by which the body 50 is attachable to the brace member 70 may, but need not, be a limiting feature. Those skilled in the art will appreciate that there may be several methods that are suitable for joining these two parts. In the embodiment shown, for example, the brace member 70 and the body 50 are joinable by way of a cantilever snap fit joint (best shown in FIGS. 11-13). The brace member 60 includes pairs of opposing cantilever arms 68 disposed on its bottom side. The body 50 and the protective member 60 each include aligned, corresponding holes/bores 64, 66 that are suitable for indexing (i.e., receiving) said cantilever arms 68 (best shown in FIG. 12).

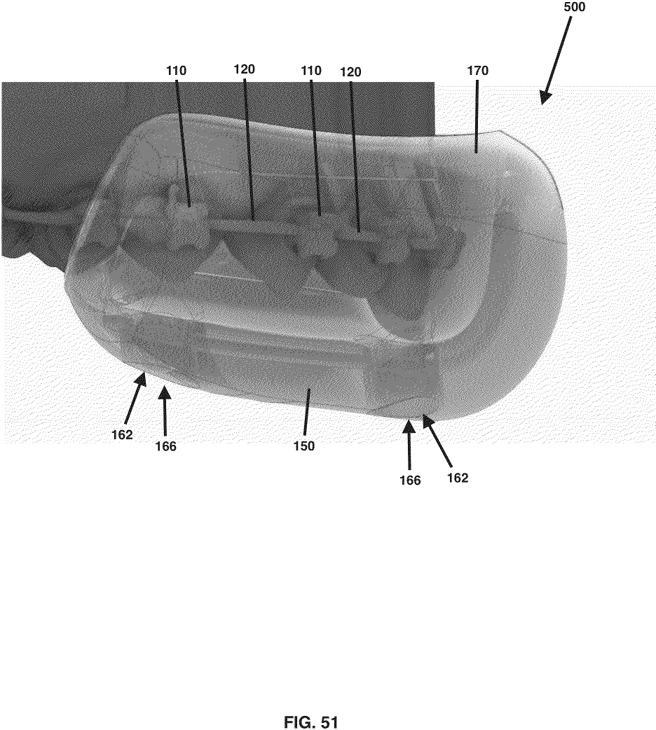

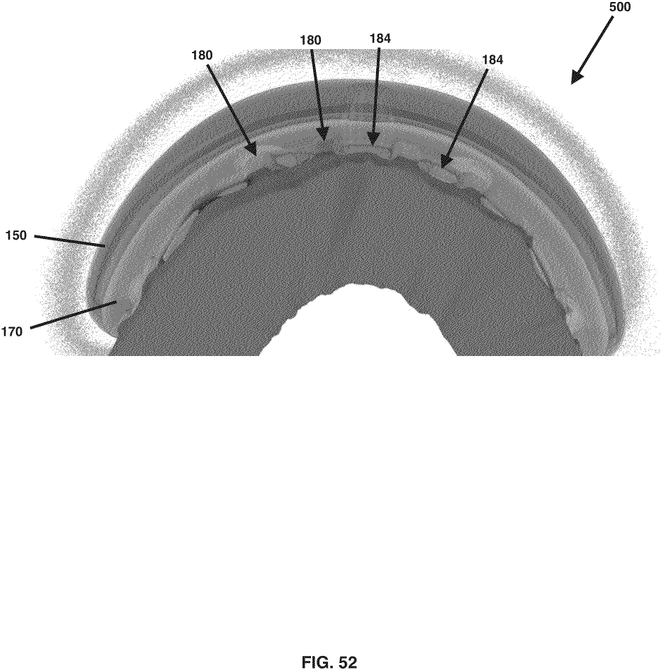

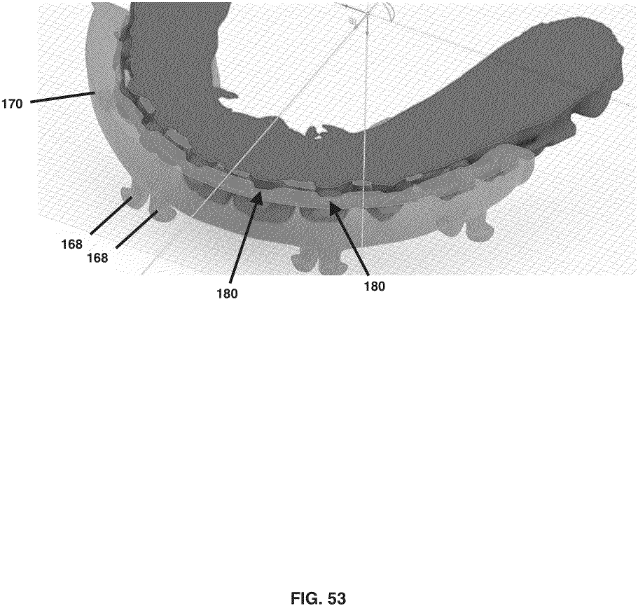

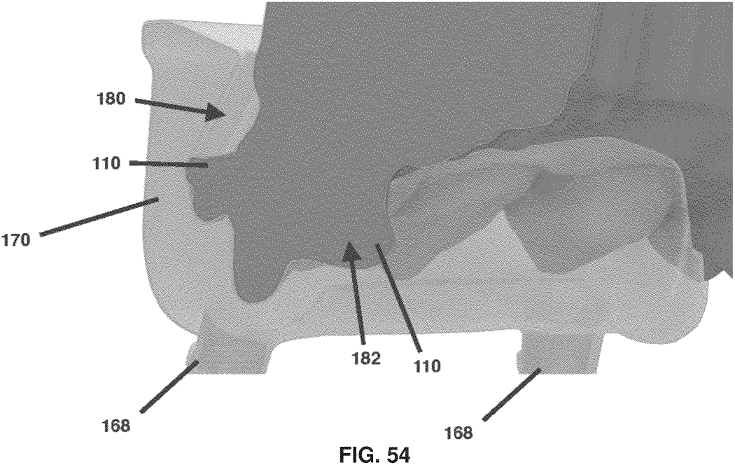

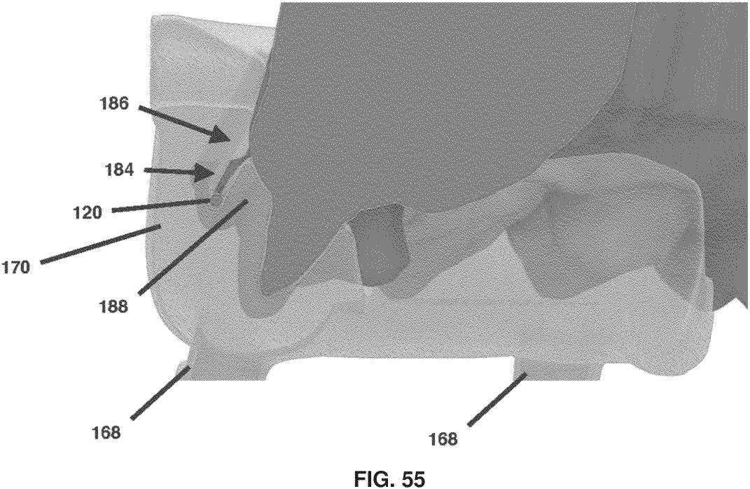

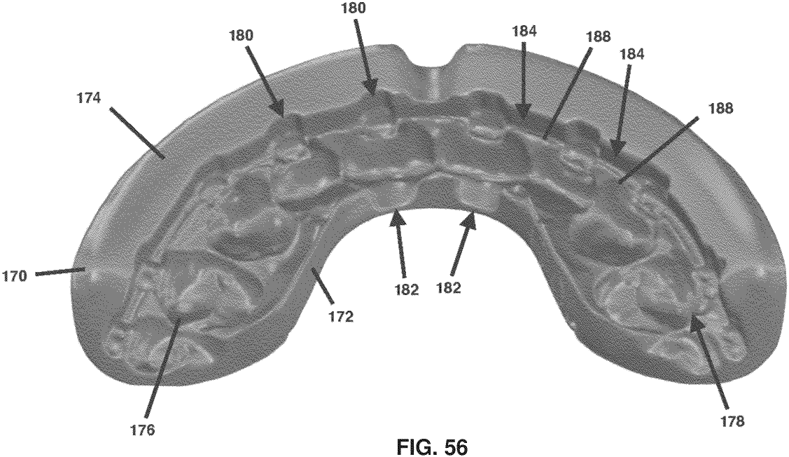

Referring to FIGS. 51-56, the present disclosure provides a third exemplary embodiment of the mouthguard assembly 500. The third embodiment 500 is similar to the second embodiment 300 in that it also includes a brace member 170 and a body 150. Here, the body 150 defines a groove for receiving the brace member 170; and the brace member 170 defines a trough 178 for receiving a user’s dental arch (FIG. 56). The brace member 170 may be secured or attached to the body 150 by any suitable means (e.g., cantilever snap fit joint 162, with holes 166 and cantilever arms 168). While not necessarily required, it is contemplated that the body 150 may also have embedded a protective member for imparting rigidity to the body 150.

Notably, the brace member 170 of the third embodiment 500 is specifically designed to accommodate users with dental braces. This brace member 170 features a number of slots defined in its anterior and posterior walls 174, 172 (along their respective trough-facing sides) that provide space for receiving various components of dental braces (e.g., brackets 110 and arch wires 120). Slots in the anterior wall 174 enables the brace member 170 to accommodate forward-facing (i.e., facial side) braces, whereas slots in the posterior wall 172 enable the brace member 170 to accommodate rear-facing (i.e., lingual-side) braces. Other embodiments may vary by only featuring one or the other (i.e., anterior wall slots or posterior wall slots) without departing from the scope of the present disclosure.

Preferably, brace member 170 may be fabricated with a trough 178 having a fitment ranging from about 50 microns to about 200 microns.

The slots defined in the bracket member can generally be categorized into two types - bracket slots and wire slots. Bracket slots are configured to receive the brackets 110 of dental braces and wire slots are configured to receive sections of the arch wire 120 connected to the brackets. In the embodiment shown, there are bracket slots 180, 182 defined in both the anterior and posterior walls 174, 172, and wire slots 184 defined in the anterior wall 174 only.

It is contemplated that other types of slots may be defined in the anterior and/or posterior walls 174, 172 of the brace member 170 so that it can receive other types of dental brace components - e.g., springs and elastics used for applying more force in a specific direction.

In general, bracket slots 180, 182 should open towards (i.e., define an opening facing) the trough 178 of the brace member 170. Moreover, bracket slots 180, 182 should extend vertically to the top of the wall they are defined in, starting from a point approximately mid-height about that wall. This design enables brackets 180, 182, which are adhered to surfaces of a user’s teeth, to be inserted into a bracket slot 180, 182 from the top of a wall and slide downwards through the bracket slot 180, 182 as the user inserts his/her teeth into the brace member trough 178.

Notably, the bracket slots 182 in the posterior wall 172 extend entirely through it, whereas the bracket slots 180 in the anterior wall 174 only extend partially through it. This is due to the fact that the anterior wall 174 is thicker than the posterior wall 172. As a result, when a user wears the brace portion 170 the anterior wall 174 will entirely cover the user’s forward-facing braces. In contrast, the user’s rear-facing braces will remain mostly exposed. As a practical matter, this design is preferred because a thicker anterior wall 174 imparts greater forward-facing protection, which is desirable because impacts experienced by the users are most likely to come from the forward-facing direction. Moreover, a thicker anterior wall 174 also prevents the user’s lips from slamming into his/her forward-facing braces when the user experiences a head-on impact. On the other hand, a thinner posterior wall 172 is desirable because it minimizes crowding in the user’s oral cavity.

If needed, the bracket slots 180, 182, as defined, may be angled to correspond with the path of a user’s teeth as they are being inserted into the brace portion 170. For example, the bracket slots 180 in the anterior wall 174 are oriented at a rear-to-front downward angle.

The wire slots 184 defined in the anterior wall 174 are generally slit-shaped; they include an elongated top-side opening 186 (FIG. 55; shown here being defined in the trough-facing side of the anterior wall) and extend downwards into the anterior wall 174 at an angle. Moreover, the wire slots 184 also extend horizontally across the anterior wall 174 between bracket slots 180. This design ensures that an arch wire 120 can be inserted into a wire slot 184 through the top-side opening 186 and slide downwards into the brace member 170 as the user inserts his/her teeth into the brace member trough 178. Moreover, as a result of this design, there is an intermediary portion 188 protruding upwards that is defined in-between the wire slot 184 and the trough 176. When a user puts on this brace portion 170, the intermediary portion 188 may slide upwards into the space in-between a section of arch wire 120 and the facial (i.e., labial and/or buccal) side of the user’s teeth/gums. In effect, this intermediary portion 188 helps to secure the brace portion 170 to the user’s dental arch and prevents the arch wire 120 from being bent inwards (i.e., towards the user’s dental arch) when the user experiences an impact (which may otherwise injure the user or damage the braces).

At this point, those skilled in the art will appreciate that the mouthguard assembly 300 of the present disclosure provides a modular solution for oral/dental protection, which may be desirable for several reasons. For one, rather than replacing an entire mouthguard when one part of the mouthguard degrades or fails, the user can simply replace that part. Further, the modularity of the mouthguard assembly 300 may enable the user to switch between configurations that are better suited for certain instances. For example, it may be the case that relatively thicker mouthguard assemblies are better suited for particularly high-impact contact sports like football or hockey, but relatively thinner mouthguard assemblies are better suited for contact sports like basketball and soccer. By switching between thicker or thinner bodies 50, a multisport athlete can configure the mouthguard assembly 300 to an appropriate level of protection while only needing one custom part - the brace member 70. This negates the need for multiple custom mouthguards which may only be suitable for a limited number of sports.

Optionally, for either the mouthguard assembly of the first embodiment 100 or the second embodiment 300, it is contemplated that flavorings may be injected to impart a flavor when the user is wearing the mouthguard assembly. Such flavorings may be injected into the bodies of the mouthguard assemblies and/or in a different component. It is contemplated that doing so would encourage people to wear the mouthguard assembly regularly. Those of ordinary skill in the art would know various flavorings that may be suitable for such a purpose.

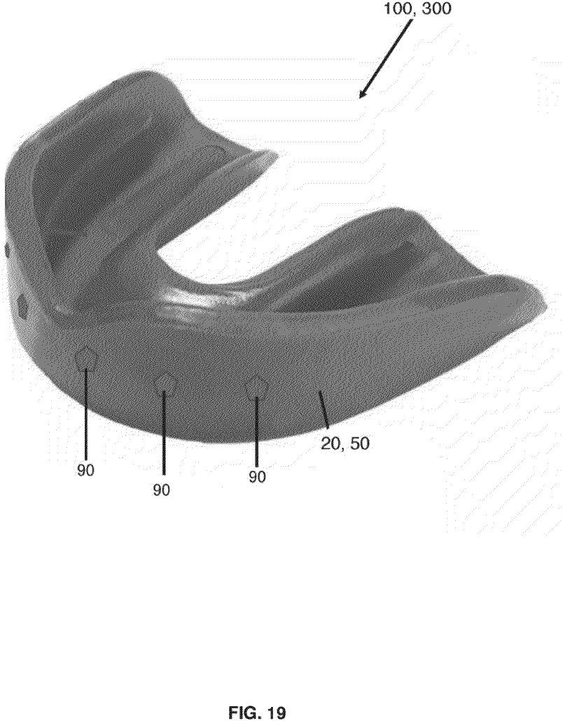

Referring to FIG. 19, items 90 may be embedded into a mouthguard assembly 100, 300, 500 such as jewels, identification labels, small electronics, and the like. Doing so may enable the user to personalize his/her mouthguard assembly, increase the functionality of the mouthguard assembly, and/or otherwise improve its overall visual appeal. As those skilled in the art will appreciate, items 90 may not be included in conventional mouthguards because impacts to such mouthguards may cause the items 90 to push against the user’s teeth/gums, causing discomfort and possible injury. However, here, the mouthguard assemblies 100, 300, 500 of the present disclosure provides a clear improvement over these conventional mouthguards because the inclusion of a protective member 40, 60 shields the user’s teeth and gums from the items 90.

Items 90 may be embedded into a mouthguard assembly 100, 300, 500 by: forming cutouts by removing portions of the mouthguard assembly body 20, 50, 150 (e.g., from the front); applying a bonding agent (e.g., Permabond) to the inside of those cutouts; inserting items 90 into those cutouts (i.e., embedding); placing the removed portions back into those cutouts (e.g., over the items 90); and applying heat (e.g., from a flame) to fuse the removed portions back with the mouthguard assembly and smooth out the exterior surface.

In an alternative embodiment, items 90 may be embedded into a mouthguard assembly by: warming up a portion of the mouthguard assembly to make it more pliable; physically pushing the items 90 into the warmed-up portion of the mouthguard assembly body 20, 50, 150 until the items 90 are at least partially embedded within the mouthguard assembly; allowing the warmed up portion to cool such that the items 90 are at least semi-held in place; and applying a thin layer of laminate (e.g., EVA copolymer) over the mouthguard assembly 100, 300, 500 to seal the item 90 in place.

To further increase the visual appeal of the mouthguard assembly 100, 300, 500, it is also contemplated that mouthguard assembly bodies 20, 50, 150, protective members 40, 70, cushioning members 46, and/or brace members 70, 170 may be colorized (either in part or in its entirety). Similarly, insignia, logos, and/or text may also be provided on any given surface of a body 20, 50, 150 protective member 40, 60, cushioning member 46 and/or brace member 70, 170 as desired. In one embodiment, decals may be integrated into the mouthguard assembly 100, 300, 500 by applying a decal to the exterior surface of a mouthguard assembly 100, 300, 500 and applying a thin layer of laminate over the decal to seal the decal in place.

### Material Composition

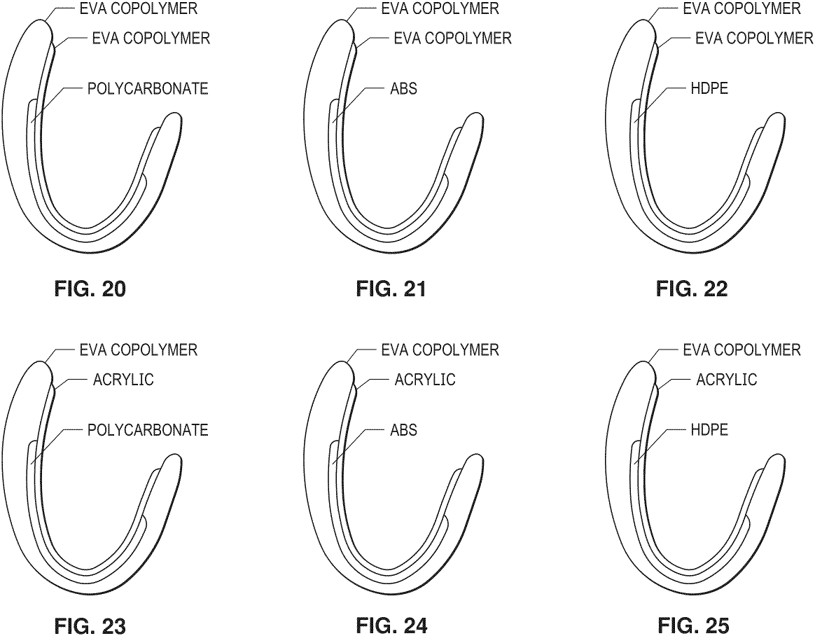

The material composition of a mouthguard assembly body, such as the body 20 of the first embodiment 100, the body 50 of the second embodiment 300, and the body 150 of the third embodiment 500, may include a material, or a blend of materials, that exhibits high durability, low compression, and limited degrees of flexibility. Several polymeric materials (i.e., plastics) may be suitable for such use. For example, vinyl polymers such as those based on polyethylene, polypropylene, polystyrene, polyvinyl chloride, and polyvinyl acetate may be appropriate. As those skilled in the art will appreciate, these polymers are commercially available in a wide variety of resin formulations, many of which may be used to form a mouthguard assembly body. Furthermore, it is also contemplated that vinyl copolymers may be suitable as well. Ethylene vinyl acetate (EVA) copolymers, in particular, are known to exhibit the desired properties described above, in addition to being generally flex-crack and puncture resistant, biocompatible, and with minimal moisture absorption. Still further, since EVAs tend to be malleable at temperatures below the boiling point of water, and will set once cooled, it is contemplated that EVAs may be used to fabricate “boil-and-bite” type mouthguards if desired. One example of a suitable EVA copolymer may include ELVAX™ available from E. I. Du Pont de Nemours Co., Wilmington, Del., 19898 (e.g., the 300, 400, and 700 series resins). The present disclosure provides several embodiments of a mouthguard assembly that feature EVA copolymer bodies (FIGS. 20-37).

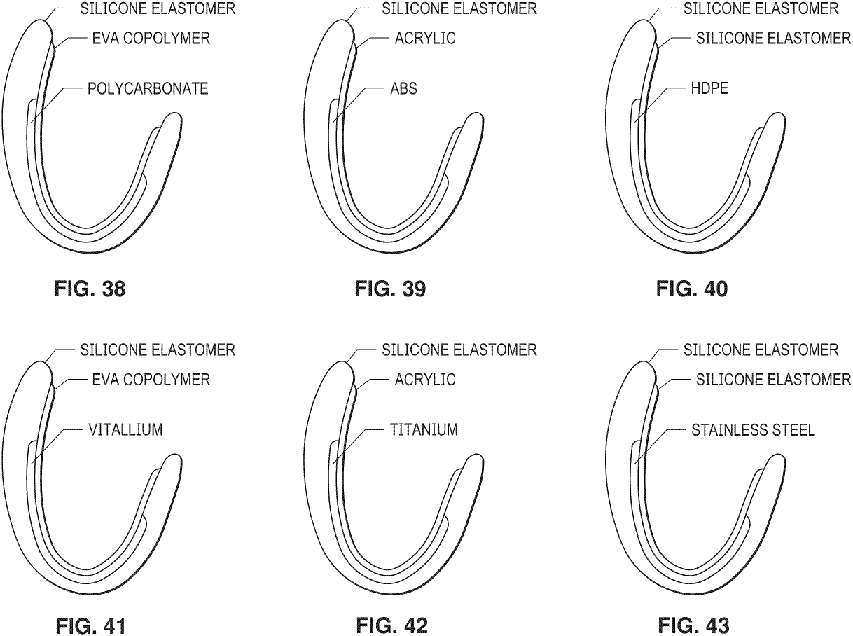

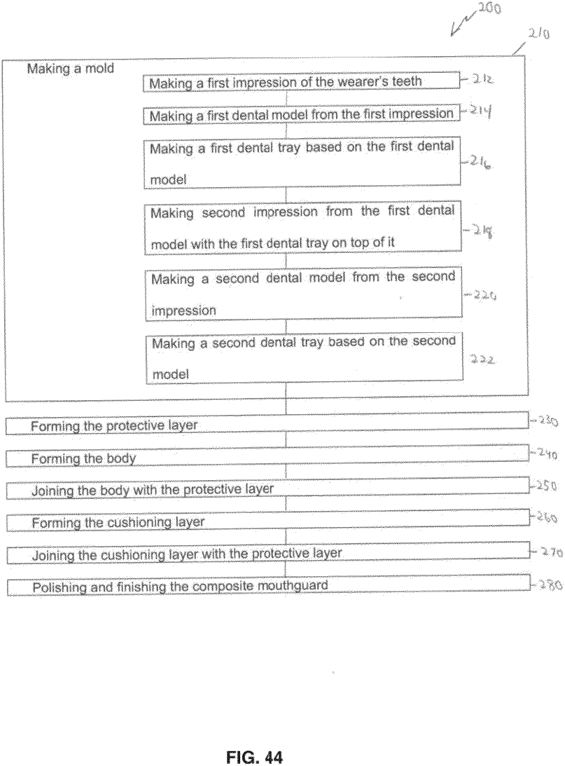

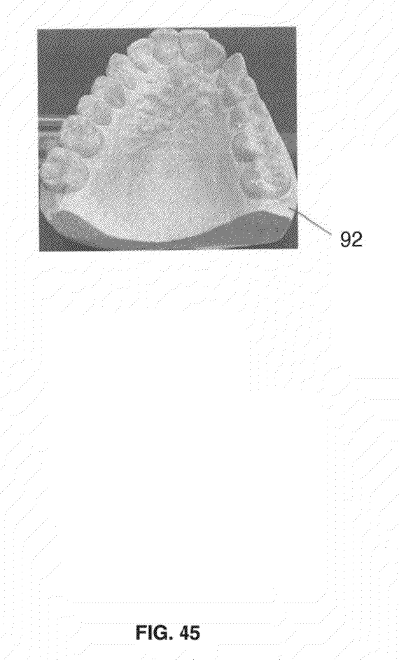

Other types of polymeric materials that may be suitable for the fabrication of the mouthguard assembly body 20, 50, 150 may include, for example, silicone elastomers (e.g., polydimethylsiloxane) (shown in FIGS. 38-43), polyester (e.g., polycaprolactone), polyurethane, polytetrafluoroethylene, thermoplastic acrylics, nylon, latex, and vulcanized rubber.

Particularly regarding the second and third embodiments 300, 500 of the mouthguard assembly, it is contemplated that the respective bodies 50, 150 may be fabricated from a material that is generally softer than the respective brace members 70, 170. Such a material may exhibit a Shore A hardness ranging from, for example, about 30 to about 80; or more preferably from about 40 to about 70; or even more preferably from about 45 to about 65. Here, it is contemplated that polymeric materials such as soft thermoplastic elastomers, thermoplastic styrenic elastomers, thermoplastic olefins, combinations thereof, and/or the like may be suitable.

Other materials that may be suitable for bodies 50, 150 of the second and third embodiments 300, 500 may include, for example, natural rubber (NR), styrenebutadiene rubber (SBR), butyl rubber (i.e., isobutylene-isoprene) (IIR), nitrile butadiene rubber (NBR), chloroprene rubber (CR), ethylene propylene diene monomer rubber (EPDM), silicone elastomers (i.e., polysiloxanes) (Q), fluorine rubbers (i.e., Fluorine Kautschuk Material) (e.g., Viton™, available from the Chemours Company of Wilmington, Delaware), ester-based polyurethanes (AU), hydrogenated acrylonitrile butadiene rubber (HNBR), fluorosilicone rubber (FVMQ), and combinations thereof.

The bodies 20, 50, 150 of the mouthguard assemblies 100, 300, 500 are generally shown throughout this disclosure as being formed in a single, continuous phase (i.e., from a material substantially devoid of pockets of air/liquid). It is contemplated, however, that the bodies 20, 50, 150 may be formed from a foam-based material (which includes pockets of air). Doing so may result in a mouthguard assembly body 20, 50, 150 that is less dense and possibly available for impregnation with additives such as flavorings.

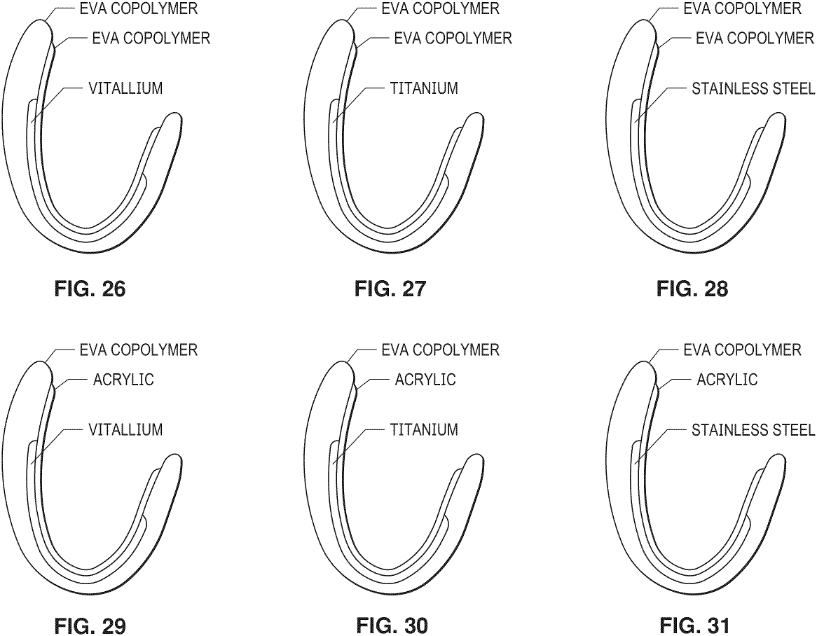

The material composition of a protective member (of any of the first, second, and third embodiments) may be fabricated from a material that exhibits high strength and rigidity. Ideally, the protective member should be able to absorb the force of an impact without fracturing or deforming. Polymeric materials that may be suitable for such use can include, for example, polycarbonate (FIGS. 20, 23, 32, and 38), acrylonitrile-butadiene-styrene (ABS) (FIGS. 21, 24, 33, and 39), high-density polyethylene (HDPE) (FIGS. 22, 25, 34, and 40), polyethylene terephthalate, high-impact polystyrene, polyether ether ketone, polyvinyl chloride, nylon and acrylic. Metallic materials that may be suitable for such use can include for example, stainless steel (FIGS. 28, 31, 37, and 43), nickel-chromium, cobalt-chromium (e.g., Vitallium) (FIGS. 26, 29, 35, and 41), titanium (FIGS. 27, 30, 36, and 42), nickel-titanium, and various alloys thereof. Those skilled in the art will appreciate that these metals, in particular, are commonly used for dental applications because they exhibit excellent biocompatibility. Other materials that may also be suitable can include, for example, gold stainless steel, aluminum, chromium, brass, bronze, tin, pewter, nickel, silver, iron, steel, magnesium, duralumin, carbon steel, solder, platinum, cast iron, aluminum bronze, gunmetal, copper, zinc, tungsten, and molybdenum, and any suitable alloys thereof. Further, there are several commercial lines of metallic alloys that may be suitable as well, such as, for example, the Inconel® line of alloys available from American Special Metals, Corp. of New Hartford, New York, USA; the Ultimet® line of alloys available from Ultimet Alloys, Ltd. of Rainham, UK; the Stellite™ line of alloys available from Kennametal, Inc. of Pittsburgh, Pennsylvania, USA (including Talonite®); the Megallium® line of alloys available from Attenborough Dental Laboratories Ltd. of Nottingham, UK; and the Monel® line of alloys available from Huntington Alloys Corp of Huntington, West Virginia, USA.

Other materials that may be suitable for forming the protective member 40, 60 may include, for example, carbon fiber, glass fiber nylon, ceramics, and/or wood-based materials. In particular, it is contemplated that glass fiber nylon may be suitable for the protective member 60 of the second embodiment 300 and of the third embodiment 500, if included.

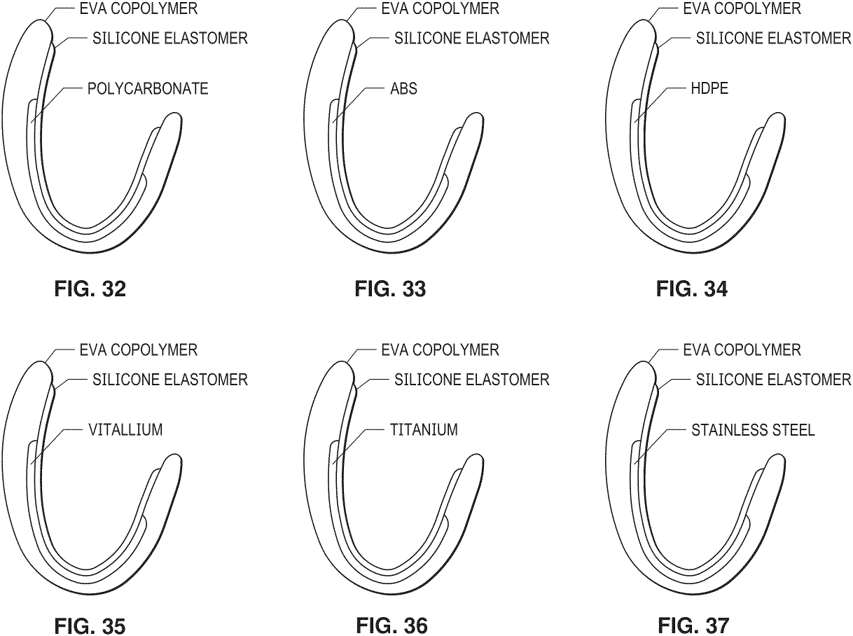

The cushioning member 46 of the first embodiment 100 may be fabricated from a material that is soft (e.g., hardness of about Shore 25A to about Shore 95A) and non-toxic. The material may be the same material used to fabricate the body 20 of the first embodiment 100 (e.g., FIGS. 20-22), but need not be (e.g., FIGS. 23-25). Preferred materials may include, for example, EVA copolymer (FIGS. 20-22, 26-28, 38, and 41), silicone elastomers (FIGS. 32-37, 40, and 43), and plasticized acrylic resins (23-25, 29-31, 39, and 42). In particular, PermaSoft® denture liner (available from Dentsply International Inc. of York, Pennsylvania) is one example of an acrylic resin (more specifically, a two-component system comprising polyethylmethacrylate, Di-n-butyl phthalate, ethyl acetate, and ethyl alcohol) that may be appropriate. For silicone elastomers, DOW CORNING™ Q1-4010 Conformal Coating, 92-009 Dispersion Coating (both available from Dow Corning Corporation, Midland, Mich.), and/or GE RTV863 Silicone Rubber (available from General Electric Company, Waterford, N.Y) may be appropriate.

The material composition of the brace members 70, 170 of the second and third embodiments 300, 500 may, but need not, be a limiting feature. It is contemplated that a semi-rigid material may be preferred so that the respective brace member 70, 170 is comfortable to wear while also sufficiently rigid to resist a significant degree of involuntary movement. Suitable semi-rigid materials may exhibit a flexural modulus ranging from about 1,800 MPa to about 2,500 MPa, or more preferably from about 2,050 MPa to about 2,130 MPa (pursuant to DIN EN ISO 20795-2:2013). Suitable semi-rigid materials may exhibit an ultimate flexural strength of about 70 MPa to about 90 MPa, or more preferably about 79 MPa to about 85 MPa (also pursuant to DIN EN ISO 20795-2:2013). Suitable semi-rigid materials may exhibit a Shore D hardness of about 20 to about 40. Such a material may provide enhanced retention to a user’s dental arch compared to softer, less rigid materials. An example of a semi-rigid material that may be suitable for the brace member 70, 170 can include acrylate/methacrylate polymeric compositions. Such a composition may include, but is not limited to, an FDA grade (i.e., Food and Drug Administration) photopolymer. Such a composition may include, but is not limited to, methacrylated oligomers and monomers, photo initiators, colorants/dyes, absorbers, combinations thereof, and/or the like. One specific type of material that may be suitable for the brace member is E-Guard dental material, available from EnvisionTEC, Inc. of Dearborn, Ml. Alternatively, it is also contemplated that the brace member may be fabricated from an overmolded shape memory material.

Other materials that may be suitable for brace member 70, 170 of the second and third embodiments may include, for example, polycarbonate (PC), acrylic (PMMA), polyamide (PA) (including nylons such as nylon 11, nylon 12, nylon 46, and nylon 66), polystyrene (PS), polypropylene (PP), acrylonitrile butadiene styrene (ABS), polyester, polypropylene, glass-filled nylon, epoxy (i.e., polyepoxides), polyethylene (PE), polyoxymethylene (POM) (i.e., acetal), thermoplastic elastomers (TPE), thermoplastic polyurethane (TPU), polyethylene terephthalate (PET), and combinations thereof.

### Fabrication Methods

Referring to FIG. 44, depicted is a method 200 for manufacturing the first embodiment 100 of the mouthguard assembly. However, it is contemplated that one or more of the following steps may also be suitable for forming one or more parts of the second embodiment 300 of the mouthguard assembly as well (particularly the second embodiment body 50 and protective member 60; and particularly blocks 210 - 250). The method includes, in no particular order, the steps of forming the protective member 40 (block 230), forming the body 20 (block 240), joining the body 20 with the protective member 40 (block 250), forming a cushioning member 46 (block 260), and then joining the cushioning member 46 with the protective member 40 (block 270). Any suitable forming/joining process may be utilized to perform these steps, though it is contemplated that consideration should be given to desired material composition of each component of the mouthguard assembly 100, as well as the desired fit (ranging from a loose stock fit to a tight custom fit).

Blocks 230, 240, and 260 may be performed using any suitable forming process, the suitability of which will likely depend, at least in part, on the desired material composition of the mouthguard assembly component. For example, mouthguard assembly components that comprise a polymeric, rubber, and/or silicone-based composition may be formed using a plastic forming process such as, but not limited to, additive manufacturing (i.e., 3D printing), injection molding (including reaction injection molding), compression molding, vacuum casting, and thermoforming (e.g., vacuum forming and pressure forming). For mouthguard assembly components that comprise a metallic composition (namely, the protective member), forming processes such as casting, forging (e.g., closed die forging), subtractive manufacturing (e.g., turning, drilling, and milling), and additive manufacturing may be appropriate.

Blocks 250 and 270, in a similar sense, may utilize any suitable joining process and/or means. In general, this is likely to entail the use of adhesives (e.g., in liquid form or as a pressure-sensitive tape), but may also include the use of mechanical fasteners (rivets, bolts, screws, etc.), interreference fits (i.e., press fit, friction fit, etc.), and/or welds (including metal-to-plastic bonding processes such as laser and/or ultrasonic welding). Examples of adhesives that may be suitable here can include, for example, epoxies, cyanoacrylates, silicone-based adhesives, and UV cure adhesive systems.

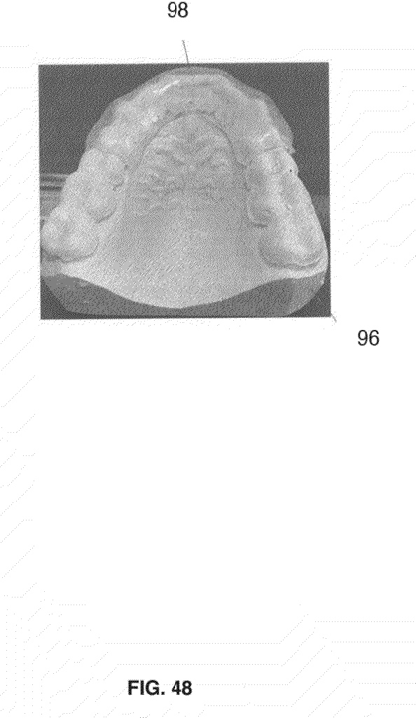

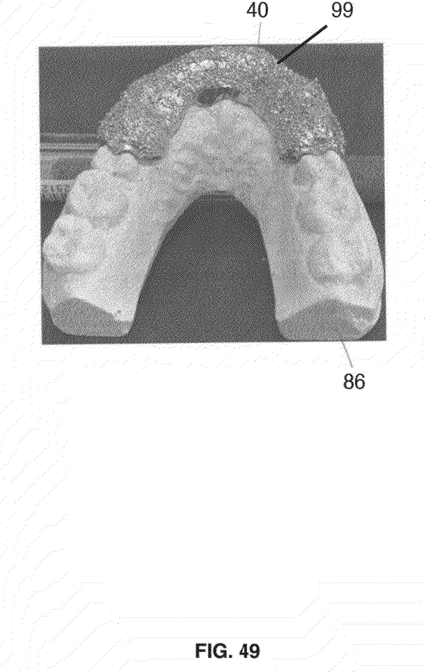

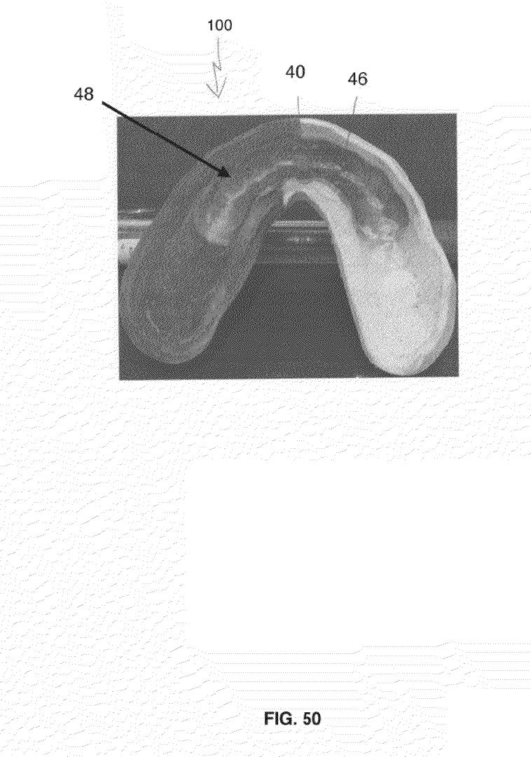

In some embodiments of the method, blocks 240 and 250, and/or blocks 260 and 270 may be performed simultaneously. That is to say, the mouthguard assembly body 20 and/or cushioning member 60 may be joined as it is formed. FIGS. 44-50 depict one method by which this may occur.

Referring to FIGS. 44-50, the method may begin with the preliminary step of making a mold (block 210). This mold may be used to impart a desired size and shape for the body, protective member, and cushioning member when they are later formed. As shown, this mold may be a custom dental model of a user’s teeth and gums.

This step may be performed by first creating a first impression of the user’s teeth (block 212). This generally entails putting an appropriate amount of impression material (e.g., alginate or polyvinylsiloxane) into an impression tray, inserting the impression tray into a person’s mouth (e.g., the user), pushing the impression tray against the person’s teeth such that the impression material completely surrounds the person’s teeth and gums, waiting until the impression material sets (e.g., becomes an elastic solid), and then removing the impression tray from the person’s mouth. At which point, a negative imprint of the person’s teeth and gums may be defined in the set impression material.

Referring to FIG. 44, a first dental model 92 (i.e., cast) may then be made from the impression of the user’s teeth (block 214). This generally entails pouring dental plaster or acrylic into the impressions, allowing plaster/acrylic to set, and then removing the finished dental model 80 from the impression.

Referring to FIG. 45, having made the first dental model 92, a first dental tray 94 may then be made from the first dental model 92 (e.g., bleaching trays) (block 216). This generally entails vacuum forming a piece of plastic around the first dental model 92, removing the first dental model 92 from the vacuum formed piece, and then cutting away excess plastic leaving only the finished first dental tray 94. It should be noted that the finished first dental tray 94 should encompass at least most of, if not all of, a dental arch.

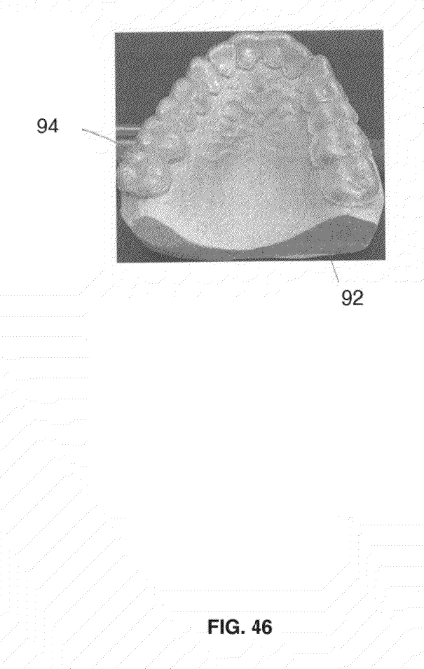

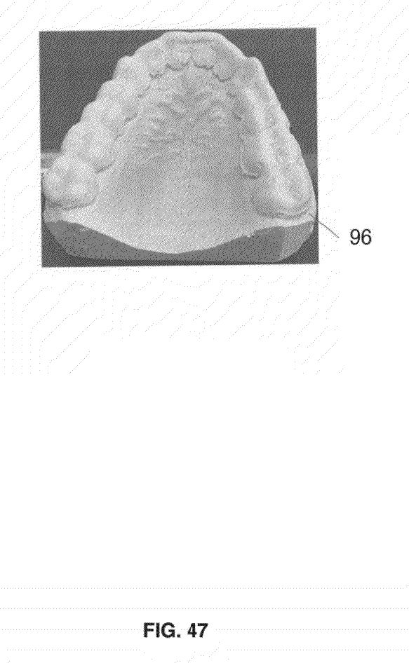

The first dental tray 94 may then be placed back onto the first dental model 92, and the previous steps (blocks 212-216) may be repeated using the first dental model 92 with the first dental tray 94 still on it. That is to say, a second impression may be created that is a negative imprint of the first dental model 92 with the first dental tray 94 on it (instead of someone’s teeth) (block 218). A second dental model 96 may then be made from the second impression (block 220, FIG. 46), as well as a second dental tray 98 from the second dental model 96 (block 222, FIG. 47). The reason for doing this is because the size and shape of the second dental tray 98 corresponds to the size and shape of the protective member 40. And since the second dental model 96 accounts for the size and shape of the first dental tray 94, the first dental tray 94, in effect, serves to approximate the size and shape of the cushioning member 46, thereby preventing the protective member 40 from being formed too small and providing room for the cushioning member 46.

As shown, a second dental tray 98 that encompasses the front eight teeth of the user’s maxillary dental arch may result in a protective member 40 that encompasses the same (FIGS. 47-49). In other embodiments, however, the second dental tray 98 may be adjusted (e.g., trimmed) to encompasses either more or less teeth. For example, protective members 40 encompassing the user’s molars may be created by cutting away portions of the second dental tray 98 such that only the portions covering the molars remain (which would be two pieces, one for each side). Various other configurations of the second dental tray 98 may be also implemented without departing from the scope of the present disclosure.

At this point, protective member 40 may be formed based on the second dental tray 98 (block 230). Any suitable forming process may be used, including the forming processes previously described. Since the protective member 40 comprises a metallic composition (e.g., vitallium), however, it is contemplated that metal forming processes such as casting, forging (e.g., closed die forging), subtractive manufacturing (e.g., turning, drilling, and milling), and additive manufacturing may be appropriate here. Further, it is also contemplated that retention beads 99 may be used to improve retention between the protective member 40 and the mouthguard assembly body 20.

From here, the protective member 40 may be placed back onto the second dental model 96 and the body 20 may be formed by vacuum forming sheets of polymeric material (e.g., EVA copolymer) around the protective member 40 and second dental model 96. This step may also involve cutting away any excess. As a result, this process not only forms the mouthguard assembly body 20 (block 240), but also simultaneously joins it to the protective member 40 (block 250). To improve retention, metal liquid bonding agent (e.g., Permabond® available from Permabond LLC of Pottstown, Pennsylvania) may also be used to bind the protective member 40, and the mouthguard assembly 100 may be placed into pressurized hot water for approximately 5 minutes to 15 minutes, but preferably about 10 minutes, to help cure the metal liquid bonding agent. Those of ordinary skill in the art of mouthguard fabrication would know various other ways of affixing the protective member 40 into the mouthguard assembly 100 such as, for example, heat molding the protective member 40 into the surrounding mouthguard material (since the mouthguard material preferably has a lowing melting point than the protective member 40), or bonding it via adhesive into the mouthguard material, or applying an additional polymer layer over the protective member 40 as it rests on the surface of the body 20 to secure the protective member 40 between the body 60 and the polymer layer.

An appropriate amount of denture liner (e.g., PermaSoft Denture Liner) may then be applied on top of the protective member 40 (along the trough 48) and bonded to it, thereby simultaneously forming and joining the cushioning member 46 (blocks 260 and 270). This step may entail applying the denture liner in a liquid/gel form and bringing the mouthguard assembly 100 into contact with the user’s teeth and gums to allow the denture liner to conform to the shape.

As a final step, the mouthguard assembly 100 may be polished and finished (block 280), thereby completing the method for manufacturing the mouthguard assembly 100.

Other methods of forming a mouthguard assembly body 20, 50, 150 may include, for example, conventional plastic forming techniques such as casting, injection molding, compression molding, and the like may be suitable. It is further contemplated that additive manufacturing techniques (i.e., 3D printing) may also be suitable. These methods may be particularly suitable for forming the bodies 50, 150 of the second and third embodiments 300, 500.

Other methods of forming a protective member 40, 60 may include, for example, conventional plastic forming techniques such as casting, injection molding, compression molding, and the like may be suitable. It is further contemplated that additive manufacturing techniques (i.e., 3D printing) may also be suitable. These methods may be particularly suitable for forming the protective member 60 of the second embodiment 300.

In embodiments where one or more protective members 40, 60 are embedded completely within the body 20, 50, 150 (having no exposed side, e.g., ref. no. 42), it is contemplated that an overmolding process may be suitable for fabrication (FIG. 13). That is to say, the protective members 40, 60 may be fabricated first, and the body 20, 50, 150 may be molded over the protective member(s). The result is a body 20, 50, 150 with one or more protective members 40, 60 embedded completely therein.

Those skilled in the art will appreciate that fabrication of the brace members 70, 170 of the second and third embodiments 300, 500 may be achieved in a variety of ways without departing from the scope of the present disclosure. For example, conventional plastic forming techniques such as casting, injection molding, compression molding, and the like may be suitable. It is further contemplated that additive manufacturing techniques (i.e., 3D printing) may also be suitable.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A mouthguard assembly comprising:
a U-shaped body comprising a posterior wall, an anterior wall, and a middle bite portion disposed between the posterior wall and the anterior wall, wherein the posterior wall and the anterior wall extend from the middle bite portion to define a groove;
a protective member at least partially embedded within the body, the protective member comprising a rigid material composition; and
a protective layer covering the teeth-side surface of the protective member.

2. The mouthguard assembly of claim 1, wherein the mouthguard assembly is custom sized for a particular user to achieve a tight fit.

3. The mouthguard assembly of claim 1, wherein the posterior wall, anterior wall, and middle bite portion are comprised of a material selected from any one or more of the following: natural rubber, styrene-butadiene rubber, butyl rubber, nitrile butadiene rubber, chloroprene rubber, ethylene propylene diene monomer rubber, silicone elastomers, fluorine rubbers, ester-based polyurethanes, hydrogenated acrylonitrile butadiene rubber, and fluorosilicone rubber.

4. The mouthguard assembly of claim 1, wherein the protective member is comprised of a material selected from any one or more of the following: gold stainless steel, aluminum, chromium, brass, bronze, tin, pewter, nickel, silver, iron, steel, magnesium, duralumin, carbon steel, solder, platinum, cast iron, aluminum bronze, gunmetal, copper, zinc, tungsten, molybdenum, and alloys thereof.

5. The mouthguard assembly of claim 1, wherein the protective layer is comprised of a material selected from any one or more of the following: natural rubber, styrene-butadiene rubber, butyl rubber, nitrile butadiene rubber, chloroprene rubber, ethylene propylene diene monomer rubber, silicone elastomers, fluorine rubbers, ester-based polyurethanes, hydrogenated acrylonitrile butadiene rubber, and fluorosilicone rubber.

6. (canceled)

6. The mouthguard assembly of claim 1, further comprising a brace member receivable in the groove of the body, the brace member comprising a posterior wall, an anterior wall, and a middle bite portion disposed between the posterior wall and the anterior wall, wherein the posterior wall and the anterior wall extend from the middle bite portion to define a trough.

7. The mouthguard assembly of claim 6, wherein the brace member is comprised of a material selected from any one or more of the following: polycarbonate, acrylic, polyamide, polystyrene, polypropylene, acrylonitrile butadiene styrene, polyester, polypropylene, glass-filled nylon, epoxy, polyethylene, polyoxymethylene, thermoplastic elastomers, thermoplastic polyurethane, and polyethylene terephthalate.

8. The mouthguard assembly of claim 6, wherein the brace member is comprised of a material selected from any one or more of the following: nylon 11, nylon 12, nylon 46, and nylon 66.

9. The mouthguard assembly of claim 6, wherein:
the brace member defines a bottom side that comprises a pair of cantilever arms; and
the body defines corresponding holes aligned with the cantilever arms of the brace member for indexing the cantilever arms.

10. The mouthguard assembly of claim 6, wherein the brace member defines a slot in at least one of the anterior wall and posterior wall of the brace member, facing the trough, wherein the slot provides space for receiving a component of dental braces.

11. The mouthguard assembly of claim 10, wherein the slot is a bracket slot that opens towards the trough of the brace member and extends to the top of the wall it is defined in.

12. The mouthguard assembly of claim 11, wherein the bracket slot is defined in the anterior wall.

13. The mouthguard assembly of claim 12, wherein the bracket slot is orientated at a rear-to-front downward angle.

14. The mouthguard assembly of claim 11, wherein the bracket slot is defined in the posterior wall.

15. The mouthguard assembly of claim 14, wherein the bracket slot extends entirely through the posterior wall.

16. The mouthguard assembly of claim 10, wherein the slot is a wire slot that defines a top-side opening and extends horizontally across the wall it is defined in.

17. The mouthguard assembly of claim 16, wherein the brace member further comprises an intermediary portion defined between the wire slot and the trough of the brace member.

18. The mouthguard assembly of claim 1, wherein the protective member is embedded completely within the body.
